(19) United States
(12) Patent Application Publication
(10) Pub. No.: US 2006/0033809 A1
(43) Pub. Date: Feb. 16, 2006

(54) Picture transmission and display between wireless and wireline telephone systems

(75) Inventor: Mark A. Farley, San Francisco, CA (US)

Correspondence Address: RONALD M. GOLDMAN;ROTH & GOLDMAN, SUITE 500, 21535 HAWTHORNE BLVD., TORRANCE, CA, 90503, US

(73) Assignee: Mr. Jim Robinson

(21) Appl. No.: 10/915,893

(22) Filed: Aug. 10, 2004

(51) Int. Cl. H04N 7/14

(52) U.S. Cl. 348/14.01; 348/14.02

(57) ABSTRACT

A 3G-camera phone (9) user may transfer photographic images from 3G-camera phone to an image viewing device (11) associated with a residential telephone (13) accessible on the PSTN telephone network (3). Both the image viewing device (11) and telephone (13) are connected to narrowband PTSN POTS telephone line (25). Through use of a call waiting (6) feature of the networks, data transfer is performed over a single narrowband PTSN POTS line with the voice conversation put on hold. Reciprocal image transmission is also possible. Like data transfers may also be made to telephone users having broadband DSL (45, 47 FIGS. 8 & 10) or CATV (54, 57 FIGS. 9 & 11) or VoIP (82, FIGS. 10 & 11) services. An Internet (7) connected fileserver (15) uses a lookup table (23) to determine the kind of line to which the image viewing device is connected and select the appropriate routing for the image transfer.

### FIELD OF THE INVENTION

This invention relates to transmission of bit-mapped photographic images over a telephone network and, more particularly, to the transmission of bitmap images between an image enabled mobile telephony device of a wireless telephone network, such as a third generation camera (3G-camera) phone, and an image viewing device connected to a telephone station of the traditional wireline public switched telephone network (“PSTN”) or newer voice-over-Internet-protocol (“VoIP”) wireline network, particularly during the course of an ongoing voice conversation between a wireless 3G-camera phone user and a wireline telephone user. The invention also relates to a portable image viewing device and other novel components necessary or desirable in the foregoing image transmission system.

### BACKGROUND

Most persons are generally acquainted as telephone users with both wireless and wireline telephone systems. Those telephone systems permit manual (and/or automated) dial-up from a user telephone to establish a telephone connection with at least one other telephone and, thereafter, the communication of voice and/or transmission of data between the two telephones.

The traditional telephone system is the public switched telephone network (“PSTN” network). The standard telephone found at one's residence is connected into that network, typically by a pair of insulated electric conductors, the wireline that extends on telephone poles over the public streets to a central office of the telephone company physically located nearby. That portion of the telephone system represented by the telephone lines extending to one's residential telephone may be referred to herein as the plain old telephone system or “POTS”, and may also be referred to using the more specific term “narrowband PTSN POTS.” From that central office, the full telephone switching network is accessed to permit placement of local and/or long distance calls. Calls that are dialed up on the telephone keypad are routed over the network to the called telephone, located at another geographic locale elsewhere in the telephone system. When used to transfer data, the PSTN network is referred to as a “narrowband” connection due to its present limited data bandwidth of 56 kilobits per second (kb/s) when used for analog data transfers. By comparison, alternative broadband Digital Subscriber Line (“DSL”) and Cable Television (“CATV”) modem type connections are referred to as “broadband” connections, later described, due to their increased data bandwidth of typically up to 1500 kb/s.

Though less traditional, wireless telephone systems, such as cellular or PCS phone systems have made extensive inroads into the telephone business. It is understood that the term wireless system as used herein is intended to include any form of wireless communication, whether or not the technical means of the system falls within or without the traditional technical definition of wireless system, and irrespective of the path taken by the wireless signal from the 3G-camera phone through space, including via a satellite or via a land based signal amplifier and repeater stations.

Wireless users, found in great numbers everywhere enjoy the benefit of carrying a portable unit on their person wherever they may go, with the ability to contact others and remain accessible at all times to other telephone users. The wireless network provider or system, as variously known, serves as the electronic backbone behind those portable units. The wireless network provides the switching and routing functions that enables one wireless user to connect to another wireless user, or to the telephone station of a narrowband PTSN POTS user, and vice versa. The wireless network and the PSTN network contain an interface or bridge connection linking the two systems together, enabling a telephone of one type of network to establish a communication link to the telephone in the other type of network. The present invention takes advantage of that bridge connection.

A third type of known communication network is the Internet. Each individual computer connected to the Internet possesses (or is assigned) a unique Internet Protocol (IP) address that is specific to that computer. The IP address is unique numeric identifier, similar in function to a phone number, that enables each computer connected to the Internet to be individually addressed. Using an IP address, data files are transmitted as digital packets sent over the Internet network from a source computer, i.e. the addresser, to the recipient computer, e.g. the addressee. Although existing to permit data communications between computers located at widely separated locations, the Internet has been used to transmit not only data files between computers but also audio and video information (e.g. files containing audio and video) as well. Internet Protocol telephony (“IP telephony”), commonly known as Voice-over Internet Protocol (VoIP), is the transmission of telephone calls over the data networks that make up the Internet. Many traditional telephone companies already use VoIP to connect their regional offices. New and existing telephone companies, such as Vonage and AT&T, are offering such VoIP services to customers as low cost alternatives to permit placement of local and/or long distance calls.

Residential VoIP systems typically consist of a telephone adapter (“TA”) connected in series to a broadband DSL or cable modem that is in turn connected to the Internet. The TA converts the analog voice signal from legacy residential phones into digital data thereby enabling users to connect their existing analog telephone handsets to the digital VoIP network. A broadband CATV coaxial cable or DSL Internet data connection is used to carry the digitized voice signal from the TA in one's residence to the broadband CATV headend or DSL central office performing Internet Service Provider (“ISP”) functions; from there, the signal is routed to any of a growing number of VoIP networks encompassed by the Internet. Upon entering the Internet, the digital voice signal is able to access traditional PSTN telephone networks and/or newer VoIP networks, as needed, permitting users to place and/or receive local and/or long distance calls both to and/or from PSTN and, VoIP wireline telephony customers, as well as wireless telephony customers.

Unlike PSTN networks, VoIP networks cannot be used for analog data transfers and thereby do not support devices such as fax machines or V.90/V.92/56K computer dial-up modems that utilize analog data connections. However, since VoIP voice networks require either a broadband DSL or CATV Internet data connection, the broadband connection can be also be used to transfer binary data such as bit-map images or MPEG4 audio/video clips both to and/or from the image viewing device eliminating the need for a separate analog data connection altogether due to the increased efficiency of the broadband connection.

VoIP networks, combined with broadband DSL or CATV connections to the home have enabled bi-directional, real-time voice communications over the Internet, permitting the Internet to serve as a cost-effective alternative to the established PSTN Network. Both wireline and wireless telephone systems have access to the Internet (and vice-versa), the details of which are not material to the present invention. The present invention, however, is superimposed upon those communication networks, as later discussed in more detail.

Portable image capture devices capable of generating digital images, such as digital cameras and 3G-camera phones, are now in wide public use. A general goal of the present invention is to permit digital images captured by these devices, as well as other file types, to be transferred between wireless image devices and wireline image devices using at least two of the three foregoing networks (wireless/Internet/PSTN). The invention also permits digital images, as well as other file types, to be transferred between wireline image devices connected to either the Internet or PSTN. Regardless of the type of data connection or its configuration, the invention supports both singlepoint transfers (A-B), for sending data from a single source device to a single target device, as well as transfers multipoint (A-B, A-C, etc.), for sending data concurrently from a single source device to multiple target devices (such as in a conference call scenario). As known to those skilled in the art, that general goal has been attained already in one form or another by others, such as is brought out in the succeeding paragraphs. However, more specifically, a principal goal of the present invention is to permit a wireless device, such as a 3G-camera phone, to establish a voice link to a narrowband PTSN POTS telephone user and transfer a captured bitmap image, or other type of file such as an MPEG-4 audio/video clip, from the 3G-camera phone to an Image Viewing Device connected to the telephone station of the narrowband PTSN POTS user, automatically display the image or images complete with synchronized audio, video, and/or text, all without terminating the original voice call and vice-versa (in the case where an image file, other type of file, is to be sent from the Image Viewing Device to the 3G-camera phone for display on the LCD panel of that 3G-camera phone).

The 3G-camera phones in mind are sometimes referred to as third generation camera phones or, more simply, 3G-camera phones, the widely advertised wireless phones, that currently enjoy the public fancy. “3G-camera phones” are herein defined as any type of wireless imaging product including, but not limited to, 3G-camera phones, handheld PDAs, and cellular modems connected to laptop computers, and other such devices wireless imaging products that may imerge, whether or not the technical meaning of the device falls within or without the traditional technical definition of 3G-camera phone, and irrespective of the path taken by the wireless signal from the 3G-camera phone through space including via a satellite system or via a land based signal amplifier and repeater stations.

The term 3G as in “3G-camera phone” is a generic name derived from the 3rd Generation Partnership Project (3GPP), a collaboration of telecommunications standards bodies that jointly produced the standards document “Technical Specifications and Reports for a 3rd Generation Mobile System.” The specification currently supports five wireless technologies including CDMA20001xRTT (Single Carrier (1x) Radio Transmission Technology), CDMA2000EV-DO (Evolution-Digital Only), CDMA2000EV-DV (Evolution-Digital Voice), GSM-EDGE (Enhanced DataRate for Global Evolution), and WCDMA/UMTS (Wideband CDMA/Universal Mobile Telephone System) and uses a host of high-tech infrastructure networks, handsets, base stations, switches and other equipment to allow wireless handsets to offer high-speed Internet access, data, video and CD-quality music services.

A component of the present invention and a related invention referred to as an image viewing device, and later herein more fully described, is compatible with 3G-camera phones capable of transmitting voice and data either simultaneously or serially (e.g. suspending the voice call, sending data via WAP, and then resuming the voice call), and supports any GSM- or CDMA-based wireless phone/network that meets this minimum requirement regardless of the 3G-camera phone's make or model or the wireless service provider for the 3G-camera phone.

Compatible CDMA-based wireless service providers may implement any single 3G CDMA technology or combination of technologies ranging from the latest CDMA CDMA2000EV-DV technology capable of simultaneous high data rate voice and data transmission to dual CDMA mode systems that combine legacy 1x technology for voice with the higher data rate EV-DO technology for data to legacy 1x technology that multiplexes voice and data together enabling simultaneous low data rate voice and data transmission. Compatible GSM-based wireless service providers may implement either GSM Class A network or Wideband CDMA (UMTS) network both of which are capable of simultaneous voice and data transmission.

Examples of such 3G-camera phones currently offered or planned by various GSM-based and CDMA-based 3G network providers include AT&T, Cingular offering WCDMA/UMTS, Verizon currently launching a dual CDMA mode network based on CDMA20001xRTT and CDMA2000EV-DO, and Sprint currently planning to offer CDMA2000EV-DV. All 3G-camera phones, including those offered by these 3G networks, feature an email address on the Internet capable of receiving (and sending) email containing text and binary data over the airwaves and through the Internet.

As amply demonstrated in past television commercials for the 3G-camera phones, it is presently possible to take a digital snapshot of a person, thing or scene using one 3G-camera phone (in which captured image is displayed as a snapshot on the LCD panel of the phone) and transmit that snapshot to a user of another 3G-camera phone, where the snapshot is received, stored and displayed on the LCD panel of the recipient 3G-camera phone. To possess the foregoing functionality, 3G networks employ two separate communications services to transfer voice and data within the wireless network. Voice communication services are used to transfer voice calls only and data communication services are used to transfer all other non-voice media types, such as bitmap images, MPEG4 audio/video clips, ring tones, and the like. 3G data communication services utilize two separate 3G technologies referred to as the Wireless Application Protocol (WAP), used to perform data transfers over the wireless network, and the Multimedia Messaging System (MMS), used to format multimedia data such audio, video, images and text, transferred over the WAP interface.

While all wireless phones include the hardware necessary for voice communications, the additional hardware and software required for 3G WAP and MMS data services is not included as part of the basic voice-only wireless feature set of the phone. Due to the fact that 3G WAP and MMS data communication services are not required to perform voice calls, the capability to capture, process, and transmit bitmap images, as well as other file types, is marketed by the 3G vendors as optional functionality that requires an upgraded wireless phone equipped with the necessary 3G WAP and MMS hardware. Lacking that 3G WAP and MMS hardware, snapshots sent to basic voice-only wireless phones as well as wireline PSTN phones can neither be received nor displayed.

As an advantage, the present invention remedies such a deficiency in the user's residential PSTN telephone station by providing an image viewing device for the PSTN telephone station that may be connected to the existing narrowband PTSN POTS connection to supplement the capabilities of the PSTN telephone. Although portable image devices currently exist in the market, none of those devices enable the sending or receiving of bitmap images as well as other types of binary files, such as MPEG4 audio/video clips, during the course of a voice conversation between a 3G-Camera phone user and the narrowband PTSN POTS telephone user.

Currently available or planned devices that provide limited functionality compared with the present invention include the following: Internet connected desktop and laptop computers; stand-alone or networked Digital Picture Frames such as the Pacific Digital Memory Frame CEIVA 2 Digital Photo Receiver; video enhanced MP3 players such as the RCA Lyra RD2780; Portable MPEG4 players such as the Panasonic AV20; proprietary portable video players such as Handheld Entertainment's Zvue; as well as Microsoft Windows CE.NET based players such as the Viewsonic PVAP. As those skilled in the art appreciate, without significant modification none of foregoing devices possess the functionality to transfer multiple binary files, such as bitmap images or MPEG4 audio/video clips, during the course of a continuous analog voice conversation using the existing narrowband PTSN POTS connection to the PSTN network.

As another advantage, the present invention remedies a deficiency in the current method used to transfer bitmap images to PSTN users by eliminating the requirement for World Wide Web and/or Internet email connectivity. The current system requires PSTN users to possess a device, such as a MAC or PC, that possesses World Wide Web and/or Internet email capability to receive pictures sent from remotely located 3G-camera phones or to send pictures to a remotely located 3G-camera phones. 3G-camera phones typically transmit captured images using a variety of bitmap formats including, but not limited to, BMP (Bitmap) images, JPEG (Joint Photographic Experts Group) images, Graphics Interchange Files (GIF) images, and animated GIFs. Images sent from a 3G-camera phone to a PSTN user are initially converted into a single MMS message before transmittal from the 3G-camera phone to the PSTN user. The MMS message format is required in order to transfer, process, and display multimedia data, such as bitmap images or MPEG4 audio/video clips, within the wireless 3G network.

If the 3G-camera phone user sends a single image, a single MMS message containing the single image is created and sent. If multiple images are sent, a single MMS message containing up to ten images is created and sent. The maximum filesize of an MMS message containing single or multiple images is typically 100 KB. If sensitive documents or images need to be transferred using MMS, end-to-end Advanced Encryption Standard (AES) encryption can be applied to the MMS message before it is sent to the target device. To transfer encrypted MMS messages, the sending party enters a self-selected password to encrypt the message and then sends the MMS message as normal to the recipient's device where it is decrypted by entering the sender's password.

In order for the MMS message containing the bitmap images to be transferred over the Internet, it becomes necessary to convert the MMS message format specific to 3G wireless networks to the Multimedia Internet Mail Extension (MIME) format required by the Internet. To perform this conversion, 3G networks use a Multimedia Messaging Service Center (MMSC) to convert MMS messages into the MIME emails and vice versa. Upon conversion, each MMS message is reformatted as a single MIME email with a separate binary file attachment used to transfer each image. To view MIME emails, home users without a 3G-camera phone must use either a narrowband or broadband data connection in order to download each MIME email and its associated attachments. Depending on the 3G wireless provider sending the message, the home user may be required to download the message using Internet email, a web-based HTTP file transfer, or a combination of both methods.

Many products capable of displaying 3G-camera phone images (or images from a digital camera) do not feature Internet email or web (HTTP/WWW) connectivity. That lack of capability imposes a significant limitation for the vast majority of PSTN telephone users. In order to be able to be displayed on the foregoing portable devices, the 3G-camera phone images must be stored in an intermediate delivery format compatible with the target device, such as on a magnetic memory card (Memory Stick, Compact Flash, etc.), or transferred using a tethered expansion bus, such as USB, the latter of which requires the 3G-camera phone to be located within several feet of the target display device. Alternatively, the PSTN telephone user must upload the images to a website for reformatting; and then download the reformatted images using a dedicated PSTN telephone connection for remote access. Those procedures are complex, time consuming, and inconvenient.

The foregoing operational limitations are incurred by desktop Digital Picture Frames, video enhanced MP3 players, portable MPEG4 players and proprietary portable video players. Only Internet connected desktop and laptop computers and Microsoft Windows CE. NET products have the necessary Internet connectivity to both receive and send images 3G-camera phone images as well as display them

Even if the PSTN telephone user possesses the necessary hardware, software, and Internet and email accounts, the use of a PC, MAC or CE.NET computer product to download 3G-camera phone images remains a complex procedure that is disruptive to any voice communication in progress between the 3G-camera phone user and the PSTN telephone user. That complexity is due to the fact that two different networks are being used to transfer the voice and data communications from the 3G wireless network to the target display device connected to the recipient's wireline PSTN telephone line, namely, the PSTN network for voice communications and the Internet for data communications, including bitmap images. Those two networks are normally independent of one another and operate in parallel when transferring 3G-camera phone voice and data communications

Unfortunately, users with a single narrowband PSTN POTS wireline connection are not able to access the PSTN and Internet simultaneously, i.e. in parallel. Due to the bandwidth limitations of analog PSTN narrowband PTSN POTS wireline connections, users with a single residential narrowband telephone line must access the PSTN and Internet networks separately, one network at a time, in a serial manner: PSTN (voice), then Internet (analog data), then PSTN (voice), and so on. Consequently, the transfer of 3G-camera phone images to PSTN users at such residences occurs in a disruptive serial manner, not in the more efficient and desirable parallel manner.

Thus when image information is transferred to a PSTN telephone user, the voice call must first be terminated by either one of the two users. On that termination, the PSTN telephone user must then dial-up the Internet service provider and perform multiple steps. The multiple steps typically include (a) starting an email application, (b) locating and opening the image email, (c) clicking a hypertext link within the email that opens a browser pointed to a website, (d) downloading the image file from the website to the target PC, MAC or CE.NET player of the user, (e) selecting a storage location and naming the email file, (f) viewing the image file with an image application, (g) terminating the Internet dial-up connection, and (h) redialing the 3G-camera phone caller to resume the original voice call.

Even following those steps, the 3G-camera phone images received by PSTN users performing these multiple steps may not display as intended due to the loss of MMS formatting information. For example, MMS messages containing a timed slideshow consisting of nine images will be received by PSTN users as a single MIME email with nine separate image attachments stored in binary file format and that do not automatically display as a timed presentation. Complicating the matter further, the foregoing process varies from wireless provider to wireless provider, easily confusing novice and non-technical users alike.

If multiple image files are transferred over the course of a lengthy voice conversation, the disruptive process described in the preceding paragraphs is repeated often, and adversely impacts the quality of the conversation. In homes containing either two (2) narrowband PSTN telephone lines or a one (1) narrowband PSTN telephone line and one (1) broadband DSL or CATV connection, the image transfer process remains disruptive, although less so than before. Depending on the 3G technology used by the 3G-camera phone, in some cases the 3G-camera phone user must still terminate the voice call to send an MMS message to the target PC, MAC or CE.NET player connected to the narrowband PTSN POTS PSTN telephone line. Even if the MMS message can be sent from the 3G-camera phone without terminating the voice call, images received using broadband DSL or CATV connections still suffer from the loss of MMS formatting information.

MMS slideshows received as MIME emails by display devices using broadband DSL or CATV connections may playback differently compared to 3G-camera phones due to the loss of presentation timing, audio synchronization or may require the use of a dedicated website with limited functionality (e.g. inability to save messages or download files). As an example, a timed slideshow consisting of nine images with synchronized audio, originally authored by the 3G-camera phone user as a single MMS message and then downloaded as a MIME email on the target device will be received as a text email with multiple image and audio attachments. As a result, an MMS slideshow with accompanying synchronized text and audio will not automatically display using an email client such as Outlook or Outlook Express. As an alternate method to downloading MMS messages as multi-part emails requiring manual reassembly, proprietary 3G websites (Sprint PictureMail, Verizon GetPix, etc.) can automate the process of playing back MMS slideshows tend to impose other user limitations such as the inability to download audio or text files or the inability to save messages without being a website member. For the foregoing reasons, the use of a laptop computers or CE.NET players to download 3G-camera phone images still remains problematic.

Moreover, only laptop computers and portable CE.NET products with World Wide Web connectivity and Internet email accounts have the required features and physical mobility necessary to enable users to send or receive bitmap images over any given narrowband PSTN POTS telephone line by performing narrowband data transfers using analog dial-up modems or broadband data transfers using Ethernet or WI-FI (802.11 Wireless Local Area Network). However, laptop computers represent only one third of the personal computers currently in use. The remaining two thirds of personal computers are stationary systems that possess little or no physical mobility. Hence, one must be within standing distance of the desktop computer monitor to view 3G-camera phone images displayed with stationary desktop systems.

Although the foregoing devices appear well suited to the particular purpose or task the respective manufacturers sought to address, those devices are unsuited to enabling users with a single narrowband PSTN POTS connection to actively receive, view, store, as well as send, bitmap images and other binary file types such as MPEG4 audio/video clips, to and from 3G-camera phones during the course of an ongoing telephone conversation.

A principal object of the invention, therefore, is to enable a narrowband PSTN POTS telephone user to receive, view, store, and send bitmap images and other binary file types, such as MPEG4 audio/video clips, to and from 3G-camera phones during the course of any ongoing telephone conversation while maintaining the original voice connection established between the telephone participants

Another object of the invention is to provide a user friendly system makes the process of transferring and viewing 3G-camera phone images during the course of any ongoing conversation as simple and immediate as using a standard home telephone.

Another object of the invention is to provide a system that requires no technical expertise or computer skills to install, is compatible with any given residential phone line equipped with call waiting, and operates consistently with the same features, modes of operation, and behavior regardless of the make or model of 3G-camera phone or the associated wireless network.

Another object of the invention is to significantly lower the cost of owning and operating the hardware and software currently required to transfer 3G-camera phone images by eliminating the need to purchase personal computer hardware and software as well as make monthly payments for World Wide Web access and Internet email.

Another object of the invention is to provide a system that enables a suite of photography specific functionalities not currently available in a low cost device such as the capability to interface to a wide array of USB as well legacy (LPT) printers and the capability to exchange magnetic media with capture devices such as digital cameras.

Another object of the invention is to provide an image viewing device that may be implemented as a small light-weight, ruggedized portable unit that is significantly smaller in size and lighter in weight than a typical laptop computer, and may be powered using AC power only (light weight), DC power only from alkaline batteries (low cost), or AC and DC power from rechargeable batteries (most portable),

Another object of the invention is to provide an image viewing module that may be implemented as a low-cost embedded subsystem in a larger display device such as television set. As an embedded subsystem, the image viewing module has greatly reduced parts count by leveraging key components available on the host display device such as the display, power supply, audio subsystem, I/O ports, etc. As a result, the Bill of Materials (BOM) for the image viewing module is greatly reduced versus the stand-alone version of the product enabling display manufacturers desiring such functionality to realize significant cost reductions by embedding the technology.

A still further object of the invention is to provide a system that supports both supports point-to-point (A-B) and multipoint transmission (A-B, A-C, A-D, etc) operation. Point-to-Point mode is used during two party telephone conversations to send images and/or binary files from a single source user to a single target user. Multi-point mode is used during 3 way calls or conference calls to send images and/or binary files from a single source user to two or more target users. The multi-point mode also includes the option to deliver the images and/or binary files to each target user simultaneously or to stagger the delivery by transmitting the files to each target user individually in a serial manner with a programmable delay (1-5 minutes) between each delivery.

A still further object of the invention is to provide a transfer system that offers a high degree of security by implementing user authentication, network firewalls, and optional message encryption.

A still further object of the invention is to provide an image viewing device with a scalable design that is compatible with both legacy PSTN networks and newer VoIP telephone networks. The invention enables any wireline PSTN or VoIP telephone user to receive, store, and view bitmap images as well as other binary file types, such as MPEG4 audio/video clips, transferred individually, or in groups, from any wireless 3G-camera phone without terminating the voice call, thereby enabling the telephone call participants to discuss each image or group or images as needed.

A still further object of the invention is to provide a system that enables bidirectional binary file transfers to occur between call participants during the normal course of a telephone conversation between wireless 3G-camera phone users and wireline telephone users operating image viewing devices with narrowband PTSN POTS or broadband DSL or CATV data connections.

A still further object of the invention is to provide a system that enables bidirectional binary file transfers of stored bitmap images, MPEG4 audio/video files, and other types of binary data files, to occur between call participants during the normal course of an ongoing telephone conversation between wireless 3G-camera phone users and wireline telephone operating an image viewing devices with narrowband PSTN POTS or broadband DSL or CATV data connections.

A still additional object of the invention is to provide an image viewing device that automates the playback of audio/video slideshows initially created and sent by 3G-camera phones as MMS messages containing synchronized audio, video, images, and text but are eventually received as non-synchronized MIME email attachments by home users with narrowband PTSN POTS or broadband DSL and CATV connections. The invention automatically compensates for the loss of synchronization caused by the format conversion, enabling both wireless and wireline telephone users to view the identical slideshow complete with synchronized audio, video, images, and text.

A still additional object of the invention is to provide a novel means for an image viewing device to work with any 3G-camera phone capable of transmitting voice and data simultaneously or serially (e.g. suspending the voice call, sending data, then resuming the original voice call) regardless of the underlying CDMA or GSM technology.

A still further object of the invention is to provide a novel means to transmit image data between a wireless 3G network and a wireline PSTN or VoIP network while retaining the original analog voice call established there between.

A still further object of the invention is to provide a real-time, image transfer system to automatically transfer an image from a 3G-camera phone to an image viewing device connected to any of an ordinary telephone line, or connected to the Internet via any of a broadband DSL line or a CATV system.

An ancillary object of the invention is to provide an image viewing device that automatically downloads and displays image files from the Internet sent as attachments to an email message addressed to that image viewing device.

A further object of the invention is to provide a novel means to bridge the transmission of image data between a wireless telephone network and the PSTN network.

A still further object of the invention is to provide a novel means to bridge the transmission of image data between a wireless telephone network and the PSTN network while retaining any voice link established there between.

As an additional advantage of the invention, the image viewing device subsystem of the invention may also serve as a self-contained speakerphone that uses the built-in microphone and speaker.

### SUMMARY OF THE INVENTION

In accordance with the foregoing objects, the disclosed method and apparatus sends an image captured by a 3G-camera phone to an image viewing device associated with a standard narrowband POTS telephone positioned at a second location accessible through the PSTN telephone network or, in an alternate embodiment, accessible by a Voice over Internet Protocol (“VoIP”) telephone adapter (“TA”) and an associated broadband DSL or CATV Internet connection, and sends that image during the course of a earlier established voice call connection between the 3G-camera phone and that narrowband PTSN POTS telephone. Both the wireless network for the 3G-camera phone and the wireline network for the POTS telephone and image viewing device possess reciprocal Internet access and call waiting service.

To transfer 3G-camera phone images to recipients who use narrowband PSTN connections, the captured image is stored, at least temporarily, on the 3G-camera phone as a bitmap image file. An application on the 3G-camera phone tags the recipient's PSTN voice number to image files selected by the 3G-camera phone user, alerts the image viewing device with audio DTMF (touch) tones that an image file transfer is to begin, then sends the tagged images to an Internet connected fileserver using email. During that period, the voice call is muted on both the 3G-camera phone and image viewing device and a pre-recorded audio file, stored locally on both devices, is played back to both the called and calling party indicating the system is operating correctly.

A fileserver application on the fileserver receives the email from the 3G-camera phone, extracts the tagged images, and then references the tagged voice number in a lookup table to determine if the image viewing device associated with the extracted voice number possesses a narrowband (PSTN) or broadband (DSL or CATV) data connection, and, if the latter, the associated broadband email address. Since the lookup table for narrowband PSTN POTS connections either specifies the same telephone number for both voice line and data line or does not contain a lookup table entry for the data line, in which case the fileserver application presumes a narrowband PSTN POTS connection, a Remote Access Server (RAS) modem is used to dial the voice number of the PSTN user and establish a data connection with the image viewing device connected to that telephone line. The call waiting service signals the incoming call from the RAS modem to the called party during the existing voice connection between the 3G-camera phone and PSTN users.

Upon detecting a call waiting tone, an application on the image viewing device that was monitoring the narrowband PSTN POTS line flashes the line to cause the call waiting service to pause the voice conversation, placing that connection on hold, and then connects the incoming data call from the fileserver RAS modem through to the image viewing device. A data modem on the image viewing device answers the incoming call, establishes a data connection with the fileserver, and then automatically downloads the image files. Once the image files are downloaded, the image viewing device flashes the PSTN line again, causing the call waiting service to pause the data call in progress, placing the data call on hold, and releasing the original voice call from hold. The remote RAS modem at the fileserver then releases the data call from the hold by terminating the data call and dropping the line. The image viewing device alerts the 3G-camera phone that the transfer has completed using audio DTMF (touch) tones, both devices simultaneously halt playback of the pre-recorded audio file and release the line from mute, and the voice call resumes.

With the foregoing method and apparatus it becomes possible for the first time to transfer a picture from a 3G-camera phone via a PSTN connection to an image viewing device associated with a standard narrowband PTSN POTS telephone without disconnecting the ongoing voice connection between the 3G-camera phone and POTS telephone. Not only that achievement, but the method and apparatus is found compatible with existing equipment and has wide application.

As an advantage, the foregoing method and apparatus for binary file transfers is not limited to narrowband PTSN connections, but is more universal in application, also serving VoIP networks as well as broadband DSL and CATV Internet data connections. Moreover, the method and apparatus is suitable to any system in which multiple voice and data circuits may coexist in parallel even if multiplexed on a single telephone line or communication channel, even one on the Internet. As an advantage, the method and apparatus thereby achieves some of the function of existing image transfer schemes while extending that function into new areas where existing image transfer schemes prove too complex or are otherwise unacceptable.

The foregoing method can be used to transfer 3G-camera phone images to recipients using IP telephony (“VoIP”). Dissimilar to PSTN connections, VoIP networks support simultaneous voice and data communication using a single broadband DSL or CATV Internet data connection simplifying overall system operation. To support VoIP connections, the lookup table on the fileserver links the VoIP number with an Internet email address assigned to the broadband DSL or CATV connection to perform data transfers and specifies the latter assigned address when queried by the application of the fileserver. Since VoIP networks require the user to possess a broadband DSL or CATV Internet data connection, VoIP users are able to leverage their existing broadband Internet connection for data transfers in addition to VoIP communications As a result, VoIP networks use Internet email to perform file transfers.

The foregoing method can also be used to transfer 3G-camera phone images to recipients who use both narrowband PSTN POTS telephones for voice and broadband DSL or CATV Internet connections for data To support households that use PSTN connections for voice and broadband for data, the lookup table on the fileserver links the PSTN voice number with an Internet email address used to perform broadband DSL or CATV data transfers, and specifies that address when queried by the NETSERVER application of the fileserver.

As an additional feature to both the method and apparatus inventions, the image transfer process is reciprocal, enabling images stored on the image viewing device to be sent to the 3G-camera phones from PSTN connections, VoIP connections, and broadband DSL and cable modem connections.

Residential users with a single narrowband PTSN POTS telephone line and telephone may now actively send, receive, view and store bitmap images to and from 3G-camera phones during ongoing voice calls. Bitmap images, those photo-like digital snapshots, captured by 3G-camera phones, as well as other binary file types such as MPEG4 audio/video files, can be securely sent, one at time or in groups, to the image viewing device for display and/or storage. Bitmap images stored on the image viewing device (as well as other binary files, such as MPEG4 audio/video files) can be securely sent, one at time or in groups, to the 3G-camera phone for display, play and/or storage at the 3G-camera phone. Conversely, bitmap images stored on the image viewing device (as well as other types of binary files) can be securely sent, one at a time or in groups, to 3G-camera phones for display, and/or storage.

Highly compatible, the system is able to operate with any 3G-camera phone capable of running a third party application and capable of transmitting voice and data either simultaneously or serially (e.g. suspending the voice call, sending data, and then resuming the voice call).

The preferred form of image viewing device employed in the foregoing apparatus and a related invention includes a programmable system controller, a user input device such as a mouse, a secondary storage device such as a memory card, and a built-in modem. Depending on the specific implementation, the image viewing device may also include an embedded LCD panel, an I/O port such as a USB On-The-Go port (mini-A plug) for connectivity, and a rechargeable battery. Preferably, the image viewing device is small, lightweight, portable and configured to be compatible with both narrowband PSTN POTS connections equipped with call waiting, as well as faster broadband DSL or CATV connections. Rechargeable, lightweight, and adaptable, the image viewing device is as easy to operate as any single line residential touch tone phone while enabling not only the transmission (sending and receiving) of images but other binary files types as well such as MPEG4 audio/video clips.

The foregoing and additional objects and advantages of the invention, together with the structure characteristic thereof, which were only briefly summarized in the foregoing passages, will become more apparent to those skilled in the art upon reading the detailed description of a preferred embodiment of the invention, which follows in this specification, taken together with the illustrations thereof presented in the accompanying drawings.

### BRIEF DESCRIPTION OF THE DRAWINGS In the Drawings:

FIG. 1 is a block diagram of an embodiment of the image transmission system invention that provides image transfer for a 3G-camera phone to a narrowband PTSN POTS line connected image viewing device in which a standard telephone is used for voice calls and an image viewing device is used for image file transfers, as well as other binary file type transfers with the respective voice calls and data files transmitted over the same narrowband PTSN POTS line;

FIG. 2 is a more detailed block diagram of an embodiment of an image viewing device that serves as a component of the image transmission systems of FIGS. 1, 8, 9,10, and 11;

FIG. 3 is a more detailed block diagram of a second embodiment of an image viewing device of FIG. 2, wherein the image viewing device is embedded in a television set;

FIGS. 5A and 5B is a flowchart of the set up process for the image viewing device used in the embodiment of FIG. 1;

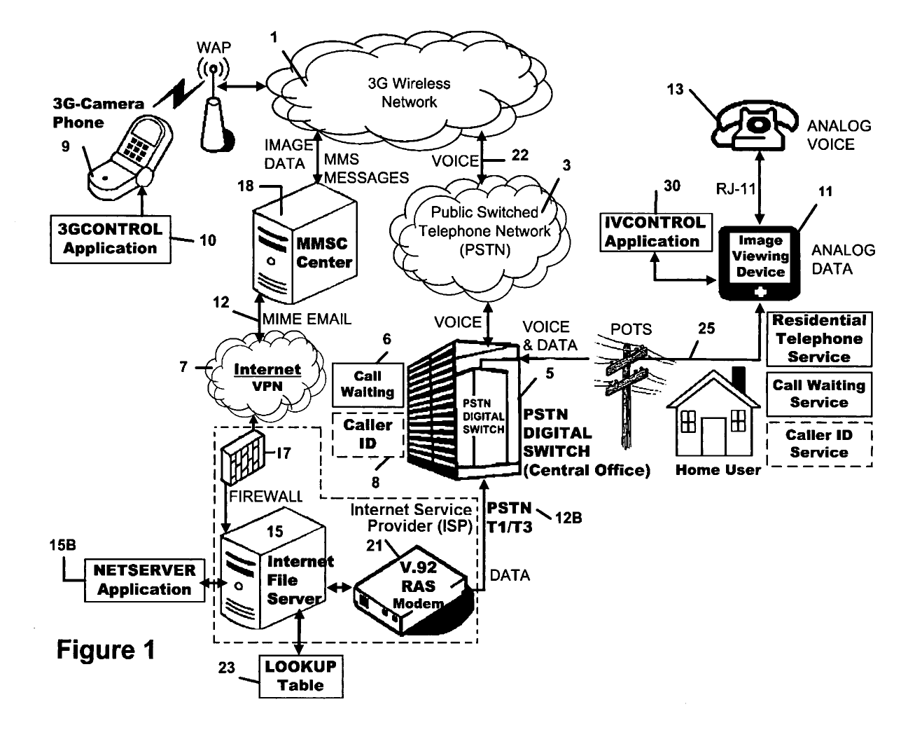

FIG. 4 illustrates a flow chart of the setup process for the 3G-camera phone used in the embodiment of FIG. 1;

FIGS. 6A and 6B illustrate a flowchart of the transfer process used in the embodiment of FIG. 1 to transfer bitmap images or other file types from a 3G-camera phone to an image viewing device over a narrowband PSTN POTS line;

FIGS. 7A and 7B illustrates a flowchart of the transfer process used in the embodiment of FIG. 1 to transfer bitmap images or other file types from an image viewing device with a narrowband PSTN POTS connection to a 3G-camera phone, the reverse direction from that of FIG. 6;

FIG. 8 is a block diagram of a second embodiment of the image transmission system invention of FIG. 1 in which image files are transferred between the 3G-camera phone and the image viewing device associated with a telephone of another telephone user by a broadband DSL or CATV modem while voice calls are carried over a PSTN to the telephone;

FIG. 9 is a block diagram of a third embodiment of the image transmission system invention of FIG. 1 in which image files are transferred between the 3G-camera phone user and the image viewing device associated with a telephone of another telephone user by a CATV line and cable modem while voice calls to that telephone are carried over a PSTN line;

FIG. 10 is a block diagram of a fourth embodiment of the image transmission system invention of FIG. 1 in which image and other binary files may be transferred between the 3G-camera phone of one telephone user and the image viewing device associated with a telephone of another telephone user by a broadband DSL modem and DSL line and voice calls to the standard telephone are carried over that same broadband DSL line by a “Voice-over-Internet-Protocol (“VoIP“); and

FIG. 11 is a block diagram of a fifth embodiment of the image transmission system invention of FIG. 1 in which image and other binary files may be transferred between the 3G-camera phone of one telephone user and the image viewing device associated with a telephone of a second telephone user by a cable modem and CATV line and voice calls to the standard telephone are carried over that same CATV line by a “Voice-over-Internet-Protocol (“VoIP”).

### DETAILED DESCRIPTION OF THE PREFERRED EMBODIMENTS

Turning to the drawings, in which like reference characters denote like elements throughout the several views, FIG. 1 to which reference is made is a block diagram of an embodiment of the image transmission system of the invention in the environment of existing communications networks, particularly, a wireless service or network 1, represented by the cloud symbol, the public switched telephone network (“PSTN”), represented by another cloud symbol, which network encompasses the long distance carrier and the associated local central office 5, and the Internet (network) 7, represented by a third cloud symbol. Those networks are conveniently accessible to one another or, as variously termed, bridged in various ways known to those skilled in the art. A bridge from the wireless network to the PSTN network is represented by bidirectional data line 22.

The Internet 7 includes the capability to provide virtual private networks (“VPN”), private high-speed pathways with guaranteed bandwidth, security, and access. A portion of the internet is configured as a VPN for quality of service. That virtual structure is achieved by having a certain amount of space (or bandwidth) on a network router dedicated to the present image transfer system. Such a network requires an enterprise service provider (ESP) to guarantee to the image transfer service applying the invention a certain bandwidth solely for use in the operation of the present image transmission system to ensure that the bandwidth is always available. As a result, the data files generated in this embodiment, such as files transmitted from 3G-camera phone 9, are effectively given the highest priority of transmission between the location of the wireless network 1 and the location of the fileserver 15. Those components may be located at widely separated locations, of hundreds or even thousands of miles. That effective high priority is based on the identity of the provider of the image transfer system, information that's included in the email message data packet, despite the fact that the priority assigned by the ISP for image files and which is included in the same image packet is quite low. Such VPN's are available for a fee from the proprietors of routers in the vicinity of the wireless network office.

Thus, the use of a VPN is not required, but, because of the obvious benefit, is highly preferred. Normal image file transmission along the internet is assigned a low priority and if the internet becomes very crowded (e.g. busy), the image file may be routed to the called party in a very indirect and circuitous manner. Both low priority and inappropriate routing serve to delay delivery of the image file from the best possible delivery time. For the present system, one desires that the image file be delivered essentially instantaneously. That delivery time cannot be guaranteed without the VPN. As one appreciates, file recipients can become frustrated and impatient if sometimes required to wait for a lengthy duration for delivery of an image file (or files) the recipient was told was being sent. The VPN use assures that the image files are delivered in a timely manner satisfying the most impatient customer.

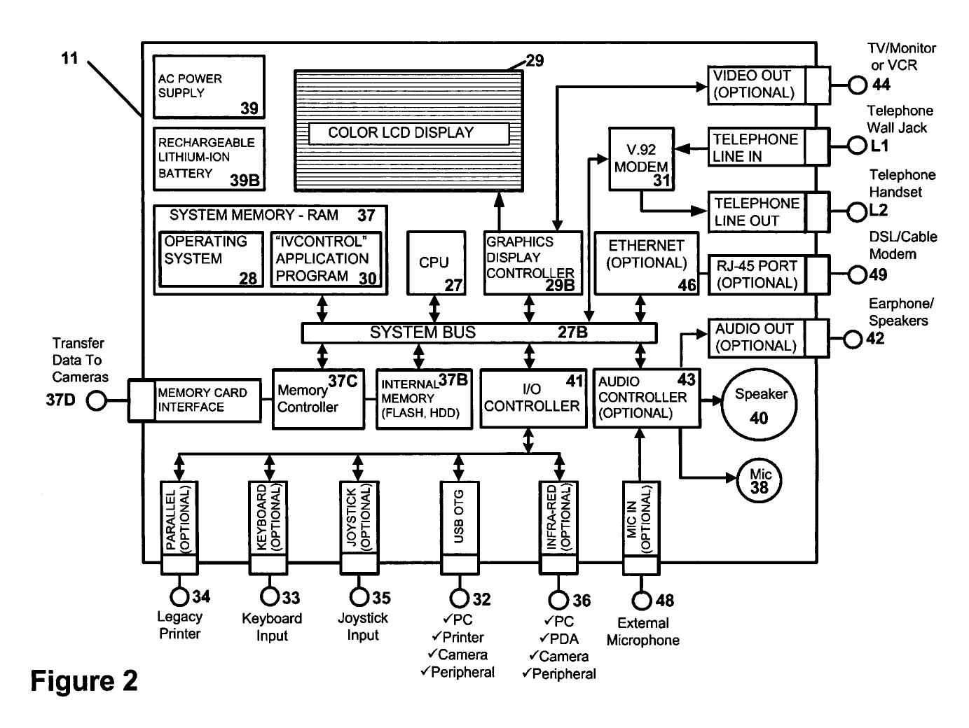

A bridge from the wireless network 1 to the Internet 7 (and, specifically, the VPN) is served by an MMSC 18, which functions as a gateway to the Internet, and the bidirectional data line 12 that extends from the MMSC to the Internet 7. The system includes a 3G-camera phone 9, an image viewing device 11 of novel structure, and a standard residential telephone receiver 13. The image viewing device 11 includes a modem, not illustrated in the figure but more fully described later in connection with FIG. 2, which permits transfer of binary files via the Internet 7.

The 3G-camera phone is wirelessly linked to the 3G network 1. The 3G-camera phone is a microprocessor controlled device and is controlled by the 3GCONTROL application 10, a computer program invoked by the user. The phone is capable of generating the familiar DTMF audio touch tones used by the network to identify numbers, alphabetical characters and functions that may be transmitted. The image viewing device 11 is also microprocessor controlled and that microprocessor is in turn controlled by IVCONTROL application 30. The image viewing device 11 is coupled to the PSTN central office digital switch 5 via narrowband PTSN POTS line 25, an ordinary multi-conductor telephone line, along with standard telephone set 13. It is understood that 3G-camera phone 9, image viewing device 11 and home telephone receiver 13 are representative of the much larger number of wireless and cell and standard telephones belonging to large numbers of users of those respective telephone networks, since a single one of each of those devices appears adequate to fully describe the operation of the various method and apparatus inventions described herein. It should also be understood that telephone receiver 13 may also be referred to as a telephone set or simply as the telephone, such being alternative names for the instrument.

The image transfer system also includes a network fileserver 15. That fileserver is accessed via POP3 (“Post Office Protocol 3”) email server for receiving incoming emails from the 3G-camera phone and by a SMTP (“Simple Mail Transfer Protocol”) email server for sending outgoing emails from image viewing devices. A firewall 17, later herein described, may be included between the fileserver and the Internet as a preferred option to prevent unauthorized Internet traffic from the entering the system. As prudent practice and although not required for operation of the system, preferably the fileserver includes or otherwise implements a hardware and/or software firewall 17 to prevent unintended harmless emails such as spam, and harmful emails such as worms, trojans and viruses, from entering the fileserver from the Internet. The file server 15 is connected to Internet 7 through optional firewall 17, and the output of the fileserver is coupled to a RAS modem 21, if the optional fire wall is included, as preferred, in the system.

RAS modem 21 connects to the central office 5 of PSTN 3 by means of a high speed data line, such as the familiar type T1 and T3 fiber optic lines that are available from PSTN telephone services providers. The network fileserver contains and runs an application referred to as the NETSERVER application 15B, which runs continuously. The NETSERVER application directs the fileserver to establish a lookup table 23 and carry out certain operations, later more fully described. The NETSERVER application may be written in any development language. That application does not require any specific hardware and operating system.

PSTN service 3 conventionally incorporates a call waiting sub-system located at the local PSTN central office 5, represented by the call waiting block 6 in the figure. The PSTN call waiting feature or service, typically available by subscription to users at extra charge, is required for the operation of the present system, and standard telephone users who are to participate and benefit from the invention, such as the user of telephone 13, are required to have those call waiting services for reasons that become apparent in the following description of operation. Although the call waiting feature of PSTN telephones is thought to be well understood by those skilled in the telephone arts because of the significance of that feature to the invention, a brief description of the function may serve as a helpful reminder.

The call waiting service allows a user to put one telephone call on hold while the user answers a second call, and, further, allows the user to alternate between the two calls. Call waiting alerts the user to incoming calls when the user is already on a call by having a distinct tone play through the user's telephone receiver. Further, the LCD panel screen of the telephone 13, if so equipped, shows that a call is incoming and, possibly if the conventional call waiting ID feature is available, the caller's phone number. Typically, to respond to a Call Waiting call, the called user simply selects and operates the Flash option (or flash button) on the appropriate telephone in use to produce a flash signal to the respective telephone network. That flash signal interrupts the narrowband PTSN POTS line for a very brief defined interval. The telephone network interprets that interrupt as a flash signal and is programmed or otherwise equipped to take appropriate action. Sending a flash signal (i.e. flashing the line) from the called telephone station, results in the original caller being placed on hold and the second call to be answered. To switch back to the first call, the user simply again flashes the line.

To respond to call waiting, the user simply selects the Flash option (or momentarily depresses the hook switch). That option puts the original caller on hold and answers the second call. To switch back to the first call, the user simply operates the Flash option a second time. That back-and-forth procedure may be repeated as many times as needed.

3G networks 1 also typically make available to 3G-camera phone users the familiar caller identification service (“Caller ID”) that enables the called party to view the telephone number of the calling party on a display, typically an LCD panel, before answering the call. That feature is available to 3G-camera phone users of 3G wireless networks and, as represented by caller ID block 8, is also available in most, if not all, PSTN networks 3. Caller ID service is typically provided to the 3G network users free of charge. However, the PSTN network providers who make available the caller ID service typically require the user to purchase the service at an additional charge. As later becomes apparent, the caller ID feature is an optional, but preferred, addition to the image transfer system.

In order for standard narrowband PTSN POTS telephone users who have a single phone line to transfer (e.g. send and receive) images, the PSTN call waiting sub-system, represented by the call waiting block 6 in the figure, located at the local central office 5 of the PSTN network, is required for reasons later described. The call waiting feature is typically available by subscription to the PSTN user at an extra charge.

To activate call waiting during an ongoing call, the PSTN user simply selects and operates the flash option or flash button on the telephone being used, referred to as flashing the line, and that action produces a flash signal to the respective PSTN telephone network. That flash signal interrupts the POTS line for a very brief, defined interval. The telephone network interprets that interrupt as a flash signal and takes appropriate action. Specifically, upon receiving the flash signal from the telephone 13, the first call is halted and placed on hold at the telephone network's digital switch 5 in the local PSTN central office, and a second line is routed in place of the first and becomes active, enabling the user to either answer a second incoming call or receive a dial tone and place a second outgoing call. Either call can be used to carry analog voice or analog data (i.e. modem). To switch back to the first call, the user simply repeats flashing the line. That flashing procedure may be repeated indefinitely with each call being placed on hold indefinitely.

Like other wireless phones, a 3G-camera phone 9 contains a microphone, a speaker, a dial pad, an LCD panel, a microcontroller, a control program or operating system 10 to program the microcontroller, a memory and a power supply containing a rechargeable battery. Depending on the design of the 3G-camera phone being used, more specifically the microcontroller used in the phone, 3G-camera phones are able to run the familiar Java2 (“J2ME”), Binary Realtime Environment for Windows (“BREW”), or Windows CE applications, among other applications. Among other functions, the memory and programmed microcontroller provides a graphical user interface for the display, maintains lists of called parties, last number redial, and other basic features in common use today. Importantly, a 3G-camera phone contains an optical sensor and lens to optically capture a visible image, the capability to store that image in memory, and display the image on the color LCD screen of the display.

As enabled by a wireless service provider 1 and the associated 3G network, the 3G-camera phone is able to wirelessly access Internet 7 and is able to send a copy of the captured image (e.g. transmit a digital binary file defining the image) to another 3G-camera phone that also has access to the Internet, as earlier described, over the Internet as digital data. The capability to send binary data files such as bitmap images over the 3G wireless network and correctly display the received images on the target device is made possible by two 3G technologies; the 3G Wireless Access Protocol (“WAP”), which is used to transfer data across the wireless network, and the 3G Multimedia Messaging Service (“MMS”), which is used to format multimedia data such as audio, video, images, and text. Multimedia files that have been formatted for MMS compatibility are referred to as MMS messages.

The method used to transfer MMS messages containing images from 3G-camera phones varies in dependence on the underlying 3G technology. The current 3G standard supports phones implementing any of the following five different wireless technologies: CDMA2000 1xRTT (“Single Carrier (1x) Radio Transmission Technology”), CDMA2000 EV-DO (“Evolution-Digital Only”), CDMA2000-EV-DV (“Evolution-Digital Voice”), GSM-EDGE (“Enhanced DataRate for Global Evolution”), and WCDMA/UMTS (“Wideband CDMA”/T“Universal Mobile Telephone System”). As an advantage the present image transfer system, as later herein described, is also compatible with 3G-camera phones capable of transmitting voice and data either simultaneously or serially (e.g. suspending the voice call, sending data, and then resuming the voice call). The image viewing device 11, later described in greater detail, can be used with any 3G-camera that meets this minimum requirement regardless of the phone's underlying GSM or CDMA technology.

In brief, to send an image (or images) during an ongoing conversation (or, more accurately, during a planned break in a conversation), when activated by the user, an application running on the 3G-camera phone temporarily places the existing voice call on hold, establishes a data connection with the wireless provider, and then sends a single MMS message to the private email address of the fileserver. The MMS message format acts as an envelope containing up to ten images addressed to image viewing device 11 by using the voice phone number of the target image viewing device as the address. Upon receipt by the fileserver, an application running on the fileserver opens the message, extracts the voice number serving as the message's target address, and searches for the voice number in a lookup table to determine what data address (if any) should be used to send images to the image viewing device associated with the given voice telephone number. If the message recipient's image viewing device is connected to a narrowband PSTN POTS line, a numeric telephone number will be stored as the value in the lookup table for the data address. If the data address value is null (empty) or invalid (e.g. different from the ongoing voice call), the application will default to setting the data address of the image viewing device equal to the telephone number of ongoing voice call. The application then forwards the images to the data address by using a RAS modem to dial the telephone number. The PSTN call waiting subsystem 6, implemented by the digital switch 5 at the local PSTN central office of the phone company receives the incoming call from the RAS modem to the phone number of the image viewing device 11, and, upon detecting that the line is busy, sends a distinctive call waiting tone to the telephone station 13 of the narrowband PTSN POTS user who is actively talking with the 3G-camera phone caller on the first line before being placed on hold. That tone is also detected by the image viewing device 11 connected to the same narrowband PTSN POTS telephone line. Upon detecting the call waiting tone, the image viewing device 11 automatically flashes the first line, placing that telephone line on hold from the PSTN central station end as well, and enables the second line, allowing the incoming data call from the 3G-camera phone 9 to be answered by the image viewing device. Upon receiving all the images transferred during the second call, image viewing device 11 flashes the line again, bringing the first line to the active condition by releasing the hold so that the voice conversation may resume. The second line is automatically terminated and the parties may resume the conversation on the first line or conclude and end the conversation. As described in the succeeding sections, dialing of the image viewing device is accomplished by modem 21.

Conversely, for the image viewing device to send images to the 3G-camera phone 9, the image viewing device flashes the narrowband PTSN POTS telephone line 25, placing the call that was on that line on hold (at the central office 5), and enables a second line (at the central office) which supplies a dial tone over line 25 to the image viewing device, allowing an outgoing data call to be dialed by the image viewing device. Upon detecting an incoming MMS message, an application running on the 3G-Camera phone user temporarily places the voice call on hold, if necessary, and establishes a WAP data connection with the 3G network 1, and then receives a single MMS message, containing up to ten bitmap images, addressed to the email address of the 3G-Camera phone. A more detailed description of that operation is presented in the next section. Upon sending all the image data using the second telephone line enabled by call waiting, the image viewing device flashes the line again, releasing the first line from hold and reactivating that line. The second line is then automatically terminated by the remote RAS modem 21 used to answer the data call dialed by the image viewing device.

The primary function of the lookup table 23 on fileserver 15 is to provide the voice address and corresponding data address of each 3G-camera phone 9 and image viewing device 11 connected to the system so that image files, as well as other types of binary files, are routed properly to the intended recipient. The voice address entry stored in lookup table is used to specify the eleven digit telephone number of the user's PSTN, VoIP, or wireless voice connection. For narrowband PSTN connections, the data address and voice address lookup entries will use either the same 11 digit telephone PSTN number since narrowband connections use the same PSTN telephone line 25 to transfer voice and data as previously briefly discussed. For broadband Internet data connections, the data address entry in the lookup table differs from the voice address entry and specifies an Internet email address that is associated with the user's broadband DSL or CATV modem connection. Using the lookup table scheme, the NETSERVER application 15B on fileserver 15 is able to properly route images, as well as other types of binary files, to and from a user's 3G-camera phone or a user's image viewing device by using the voice number used to dial the device. In the embodiment of FIG. 1, the image viewing device 11 is connected to a PSTN network 5 using narrowband PTSN POTS line 25 in series with telephone 13. The remaining connection choices are illustrated in the additional figures, FIG. 8 for broadband DSL, FIG. 9 for broadband cableTV, FIG. 10 for VoIP over broadband DSL and FIG. 11 for VoIP over broadband CATV.

Reference is made to FIG. 2, which presents a more detailed block diagram of image viewing device 11 earlier presented in FIG. 1. The image viewing device is universal in application since the device can be connected not only to narrowband PTSN POTS telephone lines but to broadband DSL or CATV lines also, as later herein described. The principal components of image viewing device 11 include central processing unit (“CPU”) 27, system bus 27B, system memory 37, a monitor or display 29, suitably an active matrix type LCD, and display controller 29B; memory controller 37C, memory interface 37D, input/output controller 41; audio controller 43; a modem 31, keypad input 33 (to which a keypad, not illustrated, attaches), joystick 35, memory storage 37B, microphone 38, speaker 40 and power supply 39, including a re-chargeable battery 39B; an operating system 28 for the CPU, such as the familiar Linux operating system (“OS”) as example, and the IVCONTROL application 30, the latter of which is defined by the algorithms or steps later herein described for the operation of the image viewing device. As one appreciates, the foregoing constitutes a programmed computer. The image viewing device connects to the narrowband PTSN POTS telephone line 25 at input L1 and connects to the external narrowband PTSN POTS telephone 13 via L2. The image viewing device embodiment illustrated in FIG. 2 contains a number of optional features, including a USB On-The-Go port 32, parallel port 34, infra-red port 36, external microphone input port 48, external earphone or speaker port 42, external video output 44 to a second display monitor, if desired, Ethernet controller 46 and RJ45 Ethernet port 49.

Those skilled in the art should recognize the foregoing image viewing device as a programmed computer. The computer operates in accordance with the IVCONTROL application 30, may receive manual input by the user via the keyboard or keypad, not illustrated, connected to input 33 and displays the results as required by the application on display 29 and/or speaker 40 and/or provides an appropriate output at a selected port. The IVCONTROL application contains subroutines or programs for controlling the modem 31, and the output L2 permits connection of the narrowband PTSN POTS telephone 13. Additional description of the image viewing device follows later in this specification in connection with the description of a practical embodiment.

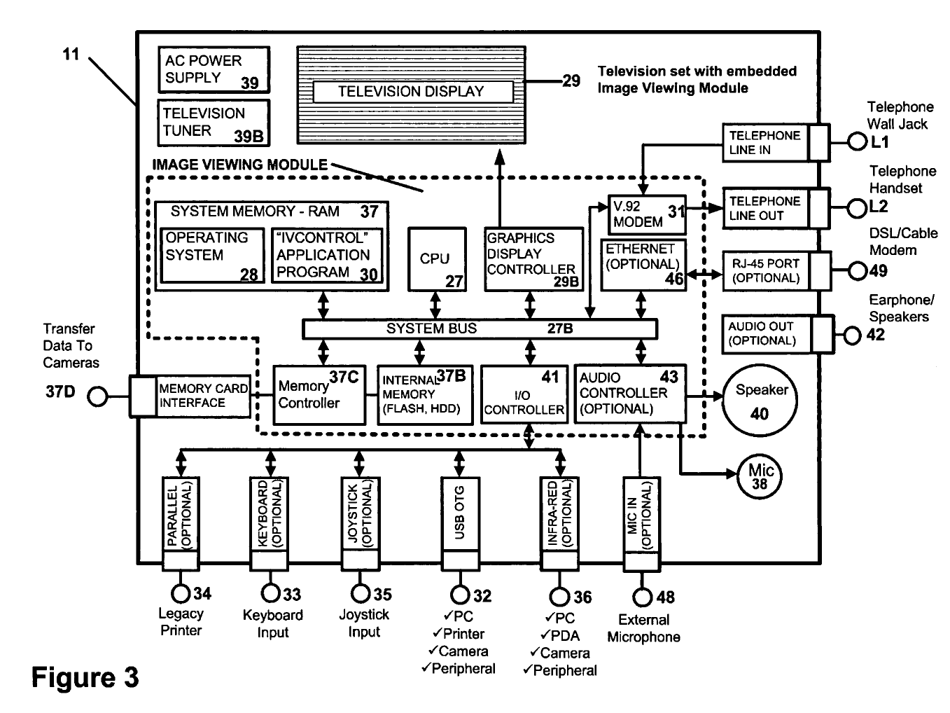

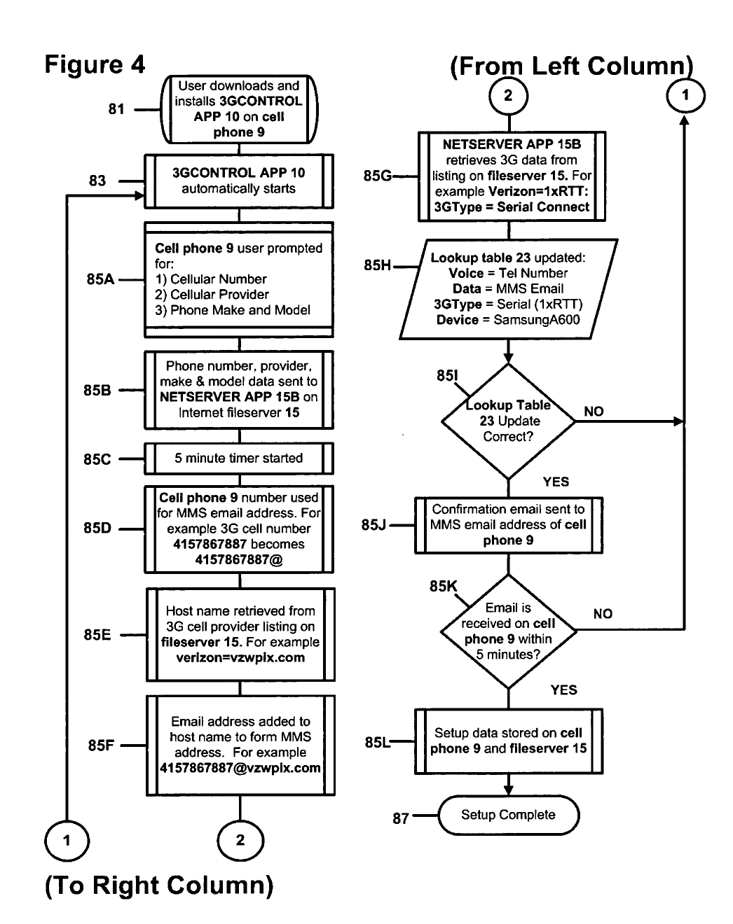

FIG. 3 illustrates a second embodiment of an image viewing device 11 in block diagram. In this embodiment, the elements which are the same as the elements in the embodiment of FIG. 2, at least in function, are identified in the figure by the same number used in the corresponding element of FIG. 1. Where a component is significantly different but shares a function with an element of FIG. 1, the component is identified by the same numeral used in FIG. 1, but which is primed. In the embodiment of FIG. 2, the television set includes a television display 29, a television tuner 50 for selecting and tuning in TV stations, and a power supply 39. The remaining components have been considered in the description of FIG. 1 and need not be repeated. The components of the image viewing device 11 are embedded inside the cabinet of a television receiver or connected via some external means. The AC power supply 39 doubles as the power supply for the television components, such as the tuner 50 and the display 29, which is typically larger in size than display 29 of FIG. 1. Display 29 serves not only as a television screen, but alternatively as the display of a computer monitor to display the computer graphic images and icons generated by the programmed computer of the image viewing device 11. Constituting also a full size television set, the image viewing device 11 is not easily moved about and will remain relatively fixed in position in the residence of the telephone user. As in the preceding embodiment, a Keypad or full keyboard, not illustrated, will be connected to keyboard input 33 and a joystick to the joystick input 35.

IMAGE TRANSFER—3G-CAMERA PHONES TO PTSN CONNECTED IMAGE VIEWING DEVICES. Continuing with FIG. 1, the functions prescribed by the respective applications running on 3G-camera phone 9, image viewing device 11 and the Internet fileserver 15 as well as the functional interactions of those components with the various telephone networks and the Internet is more easily understood by considering the functions carried out by the various components during normal system operation. Consider first the placement of a call from a 3G-camera phone 9 to a PSTN telephone 13 at a residence and the transfer of an image to an image viewing device 11 connected to the narrowband PTSN POTS line 25 with that PSTN telephone. Assume the user of a 3G-camera phone 9 took a photo of, say, a home for sale using the familiar camera function, and that digital image is stored in the memory of the 3G-camera phone as a JPEG binary image file. That stored image may be recalled, if desired, and displayed on the LCD of the 3G-camera phone, both of which are normal functions of that multi-purpose electronic appliance.

Assume further that the 3G-camera phone user dialed up a friend or business associate, who is the telephone user at PSTN telephone 13, and, in so doing, both the wireless service network 1 and PSTN network 3 (and digital switch 5) completed the dialed connection to residential PSTN telephone 13, a normal function of the two communication networks. Assume further, when the telephone connection was made, the ringer, not illustrated, in telephone 13 was supplied with current from the network and produced a ring sound, and that ring sound alerted the nearby user, who answered the call by lifting the telephone handset of telephone 13 (or otherwise took the telephone off-hook), thereby taking the telephone 13 “off-hook,” and commenced a voice conversation. That voice conversation may be as simple as the 3G-camera phone user telling the PSTN user that the person would like to show (e.g. send) the user a photo taken (or image file) of, say, another home for sale for the user to review and offer comment. Planning to receive an image, if not previously powered up, the PSTN user applies electrical power to the associated image view unit 11, conveniently situated nearby the telephone.

The telephone number that was dialed up by the 3G-camera phone user was dialed though use of the 3G-camera phone keypad, symbolically illustrated. However, many such phone numbers are typically programmed in memory in a list of frequently called wireline and wireless phone numbers in the 3G-camera phone memory so that the number may be recalled, if desired, and automatically dialed without manual insertion of the numbers on the keypad. The feature is found in all modern wireless phones.

Even if such a telephone call to alert the user of telephone 13 was not made earlier, it is possible, nonetheless, to send an image to a narrowband PTSN POTS user with whom the 3G-camera phone user recently conversed on the telephone. In that case, when electrical power from the rechargeable batteries carried in the 3G-camera phone housing is applied to energize the electronic circuits inside the 3G-camera phone, the 3GCONTROL application 10 that is run on the operating system of the 3G-camera phone automatically loads, starts and runs as a background process, transparent to the user. Initially, the 3GCONTROL application 10 attempts to determine the telephone number of the image viewing device by recalling from memory the last phone number dialed, if the 3G-camera phone initiated the call to narrowband PTSN POTS telephone 13, or by using caller ID if the 3G-camera phone did not initiate the call, but received one from that narrowband PTSN POTS phone. If caller ID identifies the caller as private or blocked, or if caller ID is not available, the 3GCONTROL application prompts the 3G-camera phone user to manually enter the telephone number of the other the other party's image viewing device. If the other party's telephone number must be manually entered, this requirement will occur only once per phone conversation when the 3G-camera phone initially attempts to send an image to the recipient's image viewing device 11. Otherwise, phone number entries are automated and manual entry is not required.

To transfer images from a 3G-camera phone 9 to image viewing device 11, the 3G-camera phone user invokes a 3GCONTROL application 10, an application resident in the non-volatile memory of the 3G-camera phone and therefore always available. It is noted that the 3GCONTROL application may be distributed preinstalled on new wireless hardware, or in the case of existing legacy wireless hardware, can be installed by downloading the necessary software from the Internet using either email or a web-based file transfer. Once downloaded onto the 3G-camera phone, the 3GCONTROL application automatically loads when the phone is powered up. Upon loading, the application runs as a silent background process until it is brought active by invoking a “hotkey” sequence using the alpha-numeric keypad of the 3G-camera phone.

Reference may be made to the flow chart presented in FIG. 4, that presents the set up or initialization of the 3GCONTROL application when first installed on the 3G-camera phone 9. When first installed, the application automatically starts and prompts the user for certain information, which the user supplies, such as wireless number and wireless provider, as well as the 3G-camera phone make and the model (see 81, 83 & 85A). That information is forwarded automatically to the NETSERVER application 15B, which uses it to generate an MMS email address (see 85D, 85E & 85F) for that particular 3G-camera phone. Since each 3G-camera phone can have multiple email addresses, each address having with different messaging capabilities (address #1 for SMS text messages, address #2 for MMS messages, etc,), the NETSERVER application sends an MMS message as confirmation to the generated email address to confirm it is a valid address capable of accepting MMS messages. If the email address generated by the NETSERVER application is incorrect, the 3G-camera will not receive a valid MMS message. If this scenario occurs, the 3GCONTROL application will prompt the user to manually enter a proper MMS email address for the 3G-camera phone and will then send that email address to the NETSERVER application and then await the MMS confirmation message for manually entered email address. Once a valid MMS message is received by the 3G-camera phone, the 3GCONTROL application will send a confirmation back to the NETSERVER application and upon receipt the NETSERVER application will update the 3G-camera phone information stored in lookup table 23: the telephone number, email address, phone type and model (see 85G & 85H). Once the NETSERVER application completes the update of the lookup table, a confirmatory email is generated and sent to the phone. The entire setup procedure must be completed before a minute timer running on the 3G-camera phone (at 85) lapses. If so completed, the setup data for the 3G-camera phone is stored on both the 3G-camera phone itself as well as the fileserver 15.

Continuing with FIG. 1, once the 3GCONTROL application is brought active, the application prompts the 3G-camera phone user to select the desired images for transfer to the image viewing device 11, located at telephone 13 of the intended recipient (e.g. the other or called party). To facilitate easy navigation and rapid viewing of many images, the 3GCONTROL application uses a browser-type interface that automatically locates stored bitmap images and displays them as thumbnail images on the 3G-camera phone's LCD panel for selection.

When browsing for images on the LCD panel of the 3G-camera phone, the 3GCONTROL application 10 automatically searches all available local and remote image storage locations. Local images are stored in the memory of the 3G-camera phone, which is typically constrained in size and thereby limited in image capacity. Thus, most wireless service providers offer 3G-camera phone customers an additional image storage location located off the phone. That remote storage location provides significantly more capacity than local storage on the 3G-camera phone. The remotely stored images are typically stored at a password protected or secure website accessed using an Internet connection by the 3G-camera phone.

3G-camera phone users are permitted to configure the 3GCONTROL application's image browser feature to search all the user storage areas for images, both local and remote, or only specific storage areas, such as local images only, as well as the order in which the search should occur, if multiple storage areas are being searched. Once all the user images have been retrieved, they are presented to the 3G-camera phone user for selection using a simple graphical interface modeled after a multi-picture photo album, typically found in existing photograph editing application programs.

Preferably, users are permitted to configure the 3GCONTROL application to default to either a thumbnail display mode that displays four thumbnail images per display or a full screen mode that displays one full image per display. While in thumbnail mode, individual images or groups of images can be expanded for full display by simply selecting them for expansion. The images in the photo album can then be browsed at the users own pace and individually selected and de-selected as desired. A single image, or groups of of up to 10 images, can be selected for transmission. If more than 10 images are selected for any given group, the 3GCONTROL application will automatically parse the images into groups of ten.

After selecting the desired images for transmittal, the 3GCONTROL application 10 permits the user to send the images immediately or, alternatively, wait until a later point in time to do so. If the user decides to send the images at a later time, the 3GCONTROL application can revert to a background process, and put back to sleep, by invoking a defined “hot key” sequence. Assuming the selected images are to be sent immediately, the user operates a “transfer” key, not illustrated, on the keypad (or an on-screen icon), and the 3GCONTROL application 10 tags each individual image or group of images with the telephone number of the recipient's image viewing device. During this period of time prior to operating the transfer key, the 3G-camera phone does not terminate, pause, or interrupt the ongoing voice conversation

In order to transmit the selected images using the 3G wireless network, the 3GCONTROL application 10 stores up to ten bitmap image files, in a predetermined display order, into a single MMS message, and then addresses and sends the MMS message containing the images to the private email address (stored in the 3GCONTROL application) of the Internet fileserver 15. If only a single image is selected, the MMS message contains only a single image. If multiple images are selected, the MMS message contains a corresponding number of images, up to ten images per message.

As an option, if sensitive documents or images need to be transferred, end-to-end Advanced Encryption Standard (“AES”) encryption can be applied to the MMS message before it is sent to the image viewing device. The foregoing security measures are known and need not be described herein in detail. To encrypt messages, the 3G-camera phone user simply enters a self-selected password before sending the message. To decrypt the message, the image viewing device recipient enters the sender's password. AES encryption is supported for MMS messages sent from the 3G-camera phone to image viewing device and vice versa

Upon selecting the “transfer” key (or command icon, not illustrated, on the LCD screen) of the 3G-camera phone 9, the 3GCONTROL application generates a short DTMF (touch) audio tone sequence that signals to the recipient's image viewing device that a file transfer is beginning, thereby enabling both devices to function in a synchronized manner. Upon detecting the DTMF audio tone, the image viewing device, and the 3G-camera phone, simultaneously mute the telephone call and begin playback of a pre-recorded audio file, stored locally in both the memory of 3G-camera phone 9 and in the memory of the image viewing device 11 as later herein described. Since muting the call normally causes callers to hear only silence, playback of a pre-recorded message, tone, and/or music during the transfer period is used to indicate the system is working properly and prevent callers from misidentifying the line as “dead” or “hung” . During that audio file playback, the voice conversation remains paused with each caller's phone muted for the period of time necessary to transfer the images between the 3G-camera phone and the image viewing device, typically one minute or so depending on signal strength, available bandwidth, and the size of the MMS message.

Immediately after synchronized audio playback begins on both the 3G-camera phone and image viewing device, the 3GCONTROL application 10 references a variable stored in the memory of the 3G-camera phone to determine if the 3G-camera phone currently in use and running the 3GCONTROL application supports a serial or a simultaneous data transfer method for voice and data to the 3G wireless network. If the variable (stored by the setup process) indicates the 3G-camera phone supports serial voice and data transfers, the 3GCONTROL application places the voice call on hold, initiates a WAP data connection to the 3G network 1, and once established, sends the MMS message (i.e. data) containing the selected images to the email address of Internet fileserver 15. Upon successful transmission of the MMS message, the 3GCONTROL application terminates the WAP data session, places the phone back in voice mode, and releases the voice call from hold. If the variable indicates the 3G-camera phone supports simultaneous data transfers, however, the voice call does not need to be paused in order to send data, and as a result, the 3GCONTROL application only needs to initiate a WAP data connection to the 3G network 1, if a data session is not currently established. Once a data session is established, the 3GCONTROL application simply sends the MMS message to the email address of Internet fileserver 15.

Since MMS messages are not compatible with the Internet, the 3G Multimedia Messaging Service Center 18 (“MMSC”) that acts as a bridge between the wireless network and the Internet automatically converts every MMS message into a MIME formatted email compatible with the Internet SMTP email system before the message enters the Internet. Conversely, the MMSC also converts appropriately formatted MIME emails with multimedia attachments (audio/video/images/text) into MMS messages compatible with the 3G network. Upon conversion of the original 3G-camera phone MMS message into a MIME formatted email, the MMSC forwards the converted MIME message onto its original destination, the email address of the Internet fileserver 15. Upon arrival at the fileserver, the NETSERVER application 15B opens, reads, and parses the MIME email to locate the voice number of the recipient, previously tagged to the images by the 3GCONTROL application. Once located, the NETSERVER application extracts the voice number from the MIME email, searches for and locates the extracted voice number in a lookup table 23, and then extracts the data address associated with voice number and stored in the lookup table. By default, if the associated data address is empty or incorrect (i.e. differs from the ongoing PSTN phone call), the NETSERVER will default to using the extracted voice number for the data address, and as a result, the destination address of the MIME email will remain unchanged. If the data address retrieved from the lookup table is valid, however, the NETSERVER application will replace the voice number with the data address, in effect re-addressing the MIME email, and will then forward the MIME email to the data address instead of the original voice number. Altogether, the entire file transfer process including these actions should take approximately one minute to perform; however, transfer times will vary depending on actual signal strength, available network bandwidth, and the message size. During this period of time, the voice call remains temporarily “paused” on both the 3G-camera phone and the image viewing device (i.e., on hold and muted) with an audio message playing to the call participants.

Upon completing the file transfer, the image viewing device signals the 3G-camera phone the transfer has successfully completed by using a short DTMF (touch) audio tone sequence. The DTMF tone sequence is used to synchronize both devices so they simultaneously halt playback of the pre-recorded audio file and stop muting the call, thereby enabling both devices to continue the original phone conversation in unison. As previously described herein, all five 3G technologies support the capability to place a voice call on hold while sending a binary file, although actual network implementations may vary. The image viewing device 11, as herein described, is compatible with 3G-camera phones 9 capable of serially transmitting voice and data by suspending the voice call, sending the data, and then resuming the voice call (i,e. CDMA 1xRT/CDMA EV-DO/GSM class B). In addition, the image viewing device is also compatible with 3G-camera phones capable of simultaneously transmitting voice and data (i,e. CDMA 1xRTT+EV-DO/CDMA EV-DV/WCDMA UMTS). Any 3G-camera phone capable of serial or simultaneous voice and data transmission can be used with the image viewing device regardless of the 3G-camera phone's make, model or associated 3G network.

The Internet fileserver 15 may be located anywhere, geographically, along the Internet wherever physical access to the Internet is available. In addition to the lookup table, the fileserver is functionally divided into two email servers: a POP3 incoming email server to receive email sent to the fileserver (typically destined for the image viewing device); and an SMTP outgoing email server to send email from the server (typically destined for the 3G-camera phone). Both the incoming POP3 and outgoing SMTP email servers are controlled by a NETSERVER application 15B. That application is loaded by the fileserver when the fileserver boots-up and thereafter runs continuously, twenty-four hours a day, seven days a week. Fileserver 15 performs the various functions prescribed by the NETSERVER application 15B, including controlling and checking the status (e.g. unread mail waiting, etc) of the email servers. The NETSERVER application performs other functions also such as; controlling the optional email server firewalls; dynamically updating the lookup tables; generating and validating MMS email addresses; assigning private email addresses to new broadband DSL and CATV user devices; authenticating user email access; opening, reading, and parsing incoming emails for email addresses; re-addressing emails; forwarding emails to broadband user devices via the Internet; and forwarding emails to narrowband user devices via RAS modems.

The 3G MMSC connects the 3G network to the Internet and acts as a gateway that automatically converts MMS messages entering the Internet into MIME formatted emails compatible with the Internet SMTP mail system. Upon conversion into the MIME format, the individual audio, video, image, and/or text files contained within the original MMS message are converted into an equal number of individual binary file attachments appended to a single MIME email. For example, a single MMS message containing three still images and two audio tracks will automatically be converted into a single multi-part MIME email with three binary image file attachments and two binary audio file attachments by the 3G MMSC. For the foregoing reason, fileserver 15 only needs to support the multi-part MIME format since the MMS message format is incompatible with the Internet SMTP email system preventing MMS messages from ever reaching the Internet fileserver.

The initial MMS message sent by the 3G-camera phone is converted into a single multi-part MIME email with binary attachments by the 3G MMSC, passes through the fileserver 17, and arrives at fileserver 15 where it is received by the POP3 email server and reassembled back into its entirety. Upon reassembly, the POP3 server immediately notifies the NETSERVER application 15B that an unread MIME email is waiting.

The NETSERVER application immediately opens the waiting MIME email and parses the contents in order to locate the voice telephone of the PSTN or VoIP recipient stored at a specific location within the email and serving as the destination address for the MIME email file attachments. Once the PSTN or VoIP voice number of the recipient is located within the email and extracted, the NETSERVER application searches for the same voice number in the lookup table to ascertain the associated data address for the PSTN or VoIP voice number. By using a lookup table scheme, the system is able to support both numeric addresses that change frequently, such as the telephone numbers of PSTN connections, as well as alpha-numeric addresses that change infrequently, such as MMS email addresses for 3G-camera phones. The data address stored in lookup table 23 for each device is supplied by the device user during a brief setup procedure that is required to establish or change a device's network connection to the image transfer system.

As later herein described, the same method is also implemented to send messages in the reverse direction, namely, from image viewing device 11 to the 3G-camera phone 9. For that function, NETSERVER application 10 extracts the 3G-camera phone recipient's voice number tagged to the MIME email attachments sent by the image viewing device and replaces that voice number with the associated data address (i.e. MMS email address) stored in the lookup table 23.

The look-up table 23 contains setup and configuration information for every narrowband PTSN POTS and broadband DSL/CATV device connected to the image transfer system, e.g. 3G-camera phones and image viewing devices 11. Since image viewing devices with broadband data connections can use either direct DSL or CATV connections to directly access the Internet, email messages addressed to these broadband devices cannot use telephone numbers, and instead, must use email addresses. As a result, if an image viewing device has a broadband connection, the lookup table 23 stores a broadband compatible Internet email address, instead of a PSTN compatible numeric telephone number, as the device data address The lookup table does not contain email addresses for narrowband PTSN POTS devices 11 (or telephones) since those devices do not directly connect to the Internet and, hence, don't possess Internet email addresses, as illustrated in FIG. 1, In addition to image viewing devices, the lookup table 23 also contains 3G-camera phone configurations, including the 3G-camera phone voice number, associated MMS email address, wireless network provider, as well as the make and model of 3G-camera phone. The NETSERVER application 15B makes reference to this lookup table each time an email is received on the fileserver by either the incoming POP3 mail server or outgoing SMTP mail server.

NETSERVER application 15B searches every MIME email received on the fileserver for the voice telephone number serving as the destination address and tagged to the MIME email attachment (e.g. image file) by the 3GCONTROL or IVCONTROL application. Once located in the MIME email, NETSERVER application 15B extracts the voice number as in the previous step. Upon extracting the voice number, the NETSERVER application searches the lookup table for the identical telephone number, and upon locating the number, extracts the data address associated with the voice number from the lookup table. Depending on the image viewing device data connection, the data address extracted from lookup table will contain either the telephone number of the recipient's (e.g. the party receiving the images) PSTN telephone line, or the private broadband email address assigned to the recipient by the NETSERVER application. Three possible data connection types are supported at present; narrowband PTSN POTS, broadband DSL, and broadband CATV. Upon retrieving the data address from the lookup table, the NETSERVER application re-addresses the MIME email by replacing the original voice telephone number tagged to the MIME attachments with the data address. The MIME email is then forwarded onto the destination specified by the data address, either a private email account for broadband connections or a PSTN telephone number for narrowband connections. The data connections supported by the image transfer system are later herein described in FIGS. 8, 9, 10 and 11.

Since the configuration information of the Image viewing device specified in the previous paragraph is necessary in order to connect the device to the image transfer system, the setup process for that device requires users to either specify the data connection. If instead the connection of the called party is listed in the lookup table as a POTS telephone line (e.g. an Internet email address was not included for the device), which is the arrangement in the embodiment of FIG. 1, NETSERVER application 15B decodes each email attachment back into its original source format (as that format existed in the camera phone memory prior to the Internet transmission) using MIME decoding. Upon re-assembly of the attachments, the file server performs an analog modem data transfer of the decoded images or other binary files, such as MPEG4 audio/video files, to the Image viewing device 11. To perform the analog data transfer, the NETSERVER application selects a modem 21, preferably V.92 compatible 21, from the fileserver's RAS modem bank and instructs the selected modem to dial the telephone number of the POTS user tagged to the image (or images). The image is then transferred from the RAS modem to the central office of the local phone company via a high speed line.

The high speed line is a multiplexed line that carries thirty separate channels. The lines are used in the proprietary network of the particular PSTN telephone service provider being used. The high speed line provides a direct connection between different cities in the network to provide a more direct routing for signals than is available from the Internet, a procedure referred to as tunneling. As recalled various kinds of data are assigned a priority level when connected for transmission along the Internet. Unfortunately, image files are large and the internet protocol for the data packets is to assign those large binary files a low priority while text files, being smaller in size are assigned a high priority in those system protocols. As a consequence, if one opts to send the image files to the called party over the Internet, one can't be certain as to when the image file will arrive at the called party destination, and, likely, the transmission time will be lengthy and denigrate the intent of the present invention for speedy transmission. Some have experienced delays of an hour to receive an image file via the Internet. To avoid that delay, direct routing is used, avoiding the internet on this leg of the system operation, ensuring the image files reach the specified destination in a timely manner. High speed lines are available from the PSTN network providers, such as the familiar type T1 and T3 fiber optic lines. Those lines are wired in a separate network proprietary to the service provider and extend, as example, between cities.

As recalled, image viewing device 11 is connected to the telephone line at the connection number of the narrowband PTSN POTS telephone. Once the PSTN network 5 completes a connection to the called telephone number (e.g. the target telephone number), the telephone network checks to determine if the called number is busy (ie. is already in use). Normally, if not busy, the network applies a ring signal to narrowband PTSN POTS line 25, and that signal operates the telephone ringer to alert the user (or other electronic appliance) at that station of the incoming call.

Continuing with the operation of the embodiment of FIG. 1, If the called number is found busy, as would be the situation when a voice call is being carried on between the particular 3G-camera phone 9 and narrowband PTSN POTS telephone 13, the particular telephone network, which in this example is PSTN network 3 and central station digital switch 5, allows the calling party line to camp on the called number without actually completing the connection, while concurrently sending a call-waiting signal over the narrowband PTSN POTS voice line 25 intended to alert the telephone user at the called number through the voice receiver of the telephone 13 that another call is waiting. However, a slightly different action occurs with the present invention.

Image viewing device 11, as illustrated in FIG. 2, contains a built-in RAS modem 31, such as a V.92 modem, that functions once a call-waiting tone is detected during a voice call. Detection is relatively straightforward. The call waiting signal is a single fixed frequency audio tone of fixed duration that is repeated at regular intervals. By coupling a low-pass filter to a detector circuit in the image viewing device, the unit detects the presence of the call waiting tone and either sets a bi-stable switch, not illustrated, to a “1” state or accomplishes the equivalent with a software switch, such as by setting a status bit or flag. The IVCONTROL application 30 running on image viewing device 11 continuously checks status of the bi-stable switch (or flag), and, if the status is found set to “1,” recognizes that a call is waiting. Upon detection of a call waiting tone, modem 31 flashes the original voice line, line 25 effectively suspending the voice call in progress between the 3G-camera phone and the image viewing device, and placing the voice call on hold at the local phone company's (e.g. PSTN network 5) digital switch. The voice line can be placed on hold as long as necessary (indefinitely if needed), while the image files are transferred, without disconnecting the voice call.

After thus flashing the line to place the original voice line on hold at the central station, the IVCONTROL application then uses built-in V.92 modem 31 to answer the incoming data call from the remote fileserver associated with modem 21. A modem-to-modem handshaking procedure commences, and once completed, a data connection, with a maximum bandwidth of 56 kbps, is established between the fileserver 15 and the image viewing device 11, which, in essence, constitutes a programmed general purpose computer.

To transfer images to and from the remote fileserver, the IVCONTROL application connects to a private POP3 email server on the fileserver 15 to receive incoming email and connects to a private SMTP email server on the fileserver to send outgoing email. To receive incoming email, the IVCONTROL application connects to POP3 server using port 110 of the image viewing device. Once connected to port 110, the IVCONTROL application transmits a POP3 account name and a password required to access the fileserver and, upon acceptance, begins to download the email waiting on the POP3 server.

On the other hand, to send email to fileserver 15, the IVCONTROL application flashes the line upon when the IVCONTROL detects user operation of the “transfer” key on the image viewing device, placing the original voice line on hold. Upon receiving a dial tone from the PSTN central station 5, image viewing device 11 uses a built-in V.92 modem 31 to dial the access number of the remote fileserver modem.

Once a data connection is established between the remote fileserver 15 and image viewing device 11, a private email system is used to transfer images to (and from) the remote fileserver. To receive incoming email, the IVCONTROL application 30 running on image viewing device 11 connects to a private POP3 email server on the fileserver using port 110. To send outgoing email, the IVCONTROL application 30 connects to a private SMTP email server on the fileserver using port 25. Once connected to either port 110 or port 25, the IVCONTROL application transmits an account name and a password required to access the incoming and outgoing email servers and, upon acceptance, begins to download email waiting on the POP3 server or upload the email to the SMTP server. By requiring passwords to both send and receive email, the image transfer system remains closed and prevents unauthorized access.

Preferably, error checking can be performed on the attachments of incoming email as received. Once the transfer successfully completes, image viewing device 11 flashes the line causing the digital switch at the central office 5 to place the existing data call on hold. The V.92 RAS modem 21 located at the fileserver then terminates the second data call, on hold at the phone company's digital switch, by dropping the connection. Upon termination of that incoming data call, the original voice call becomes active and enables the user of narrowband PTSN POTS telephone 13 to resume any earlier voice communication with the user of 3G-camera phone 9, choosing otherwise to continue or conclude that call.

Having received the image files as an email addressed to the image viewing device 11, the email application running on the processor, CPU 27, in the image viewing device 11, alerts the user of the reception of those files by displaying a dialog box on the LCD panel of the associated image viewing device. The dialog box offers the user the choice of saving the files to non-volatile memory, where the files can be stored and later retrieved, or to immediately open the files. As elsewhere herein described the image viewing device includes the familiar computer “mouse” device, not illustrated. Using the mouse to move the on-screen graphical cursor, not illustrated, associated with the mouse to point to the icon that represents the choice the user has made, and then clicking the switch on the mouse to confirm and activate that choice. Assuming the choice is for the immediate display, the application opens the received attached image file (or image files) in one or more windows of the operating system of the image viewing device and the user is able to view the image (and navigate between windows that display different images). With the user's free hand, the user can hold the standard telephone receiver to the user's ear and speak into the microphone to relate any comments about the images back to the sender. Those voice messages then propagate through the circuitry of the respective telephone systems to the 3G-Camera phone 9 of the user who sent the image files. The two parties may then continue a conversation and/or terminate the call.

FIREWALLS. Reference is again made to the firewall 17 in FIG. 1. The firewall is of known structure and/or programming. It serves as a security device to prevent harmful programs from surreptitiously entering (or leaving) the computer. As example, typical functions for the firewall of the network fileserver 15 may include any of the following structural implementations:
1) Packet filtering—in which packets (small chunks of data) are analyzed against a set of filters. Packets that pass through the filters are allowed to progress to the requesting system, and all other packets are discarded.
2) Proxy service—Information is retrieved by the firewall from the Internet and then is sent (e.i. forwarded) to the requesting system and vice versa.
3) Stateful inspection—A newer method that compares certain key parts of the packet to a database of trusted information. Information traveling from inside the firewall to the outside is monitored for specific defining characteristics, then incoming information is compared to these characteristics. If the comparison yields a reasonable match, the information is allowed through. Otherwise the information is discarded.

As one appreciates, the invention does not require a firewall in order to function properly, but in the present social environment with software vandals (e.g. hackers) inclusion of a firewall is preferable and prudent. Further the invention is not dependent on the particular feature set of any particular firewall and, as one appreciates, a wide variety of alternative firewalls may be used in the combination without departing from the disclosed invention.

UPDATING OF LOOK UP TABLE. Referring again to FIG. 1, the description of the content of lookup table 23 was earlier described, but installation of that information in the table was not. That description may now be addressed, together with 3GCONTROL application 10, running on 3G-camera phone 9, and the IVCONTROL application 30, running on the image viewing device 11. The connection configuration contained in lookup table 23 is indirectly supplied by the telephone users of narrowband PTSN POTS telephone13.

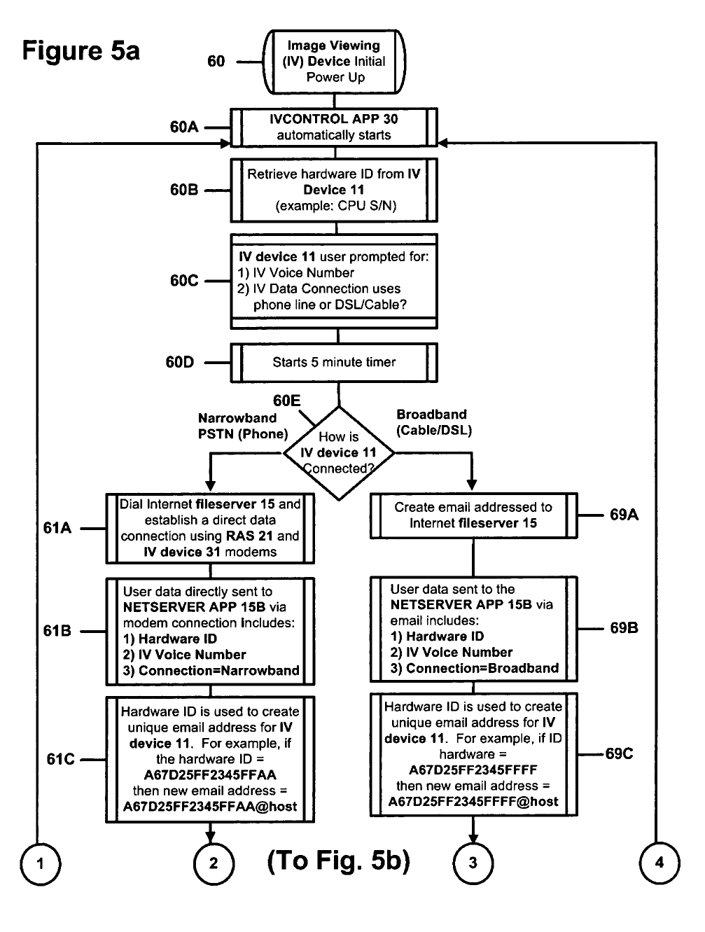

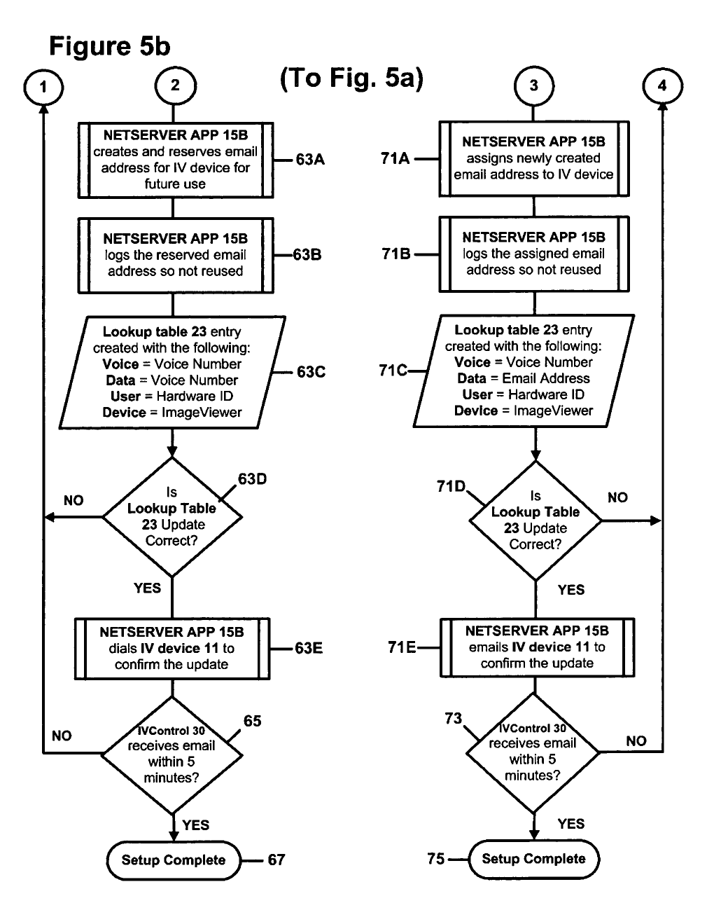

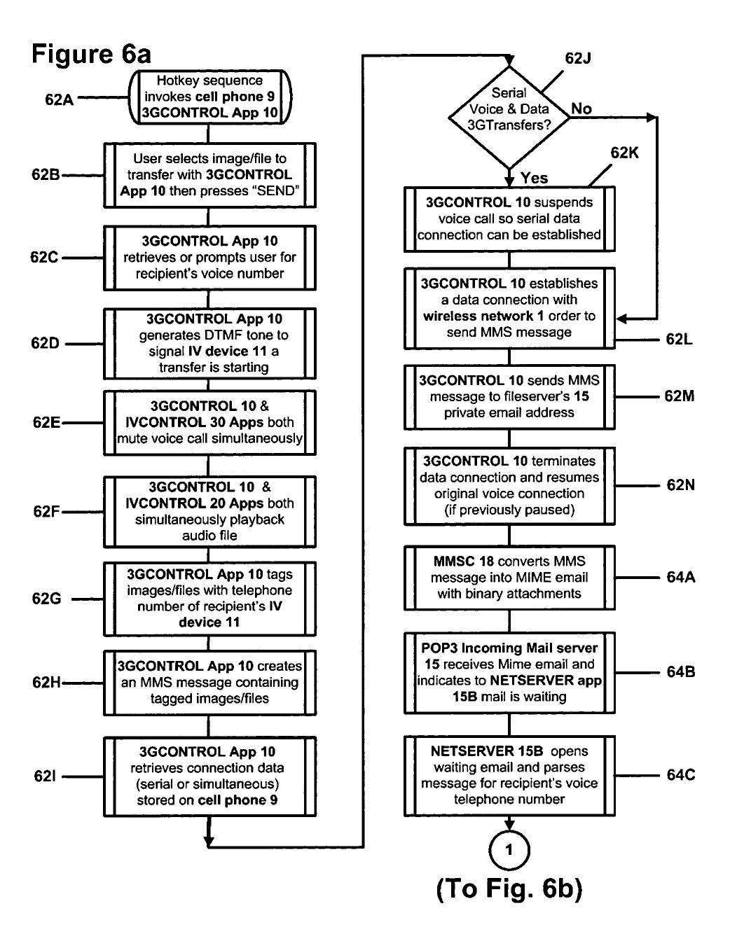

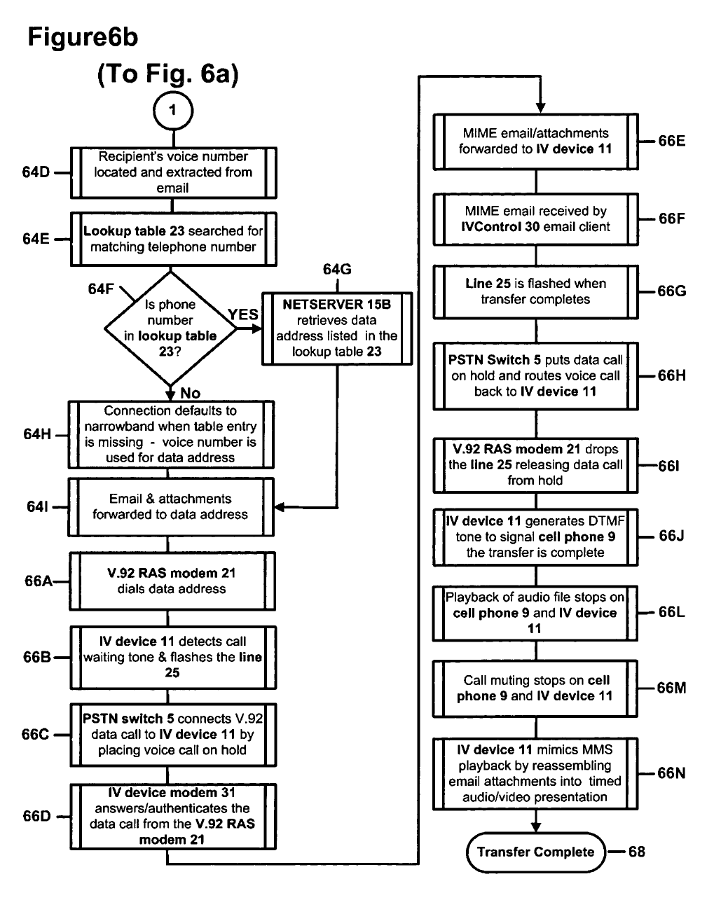

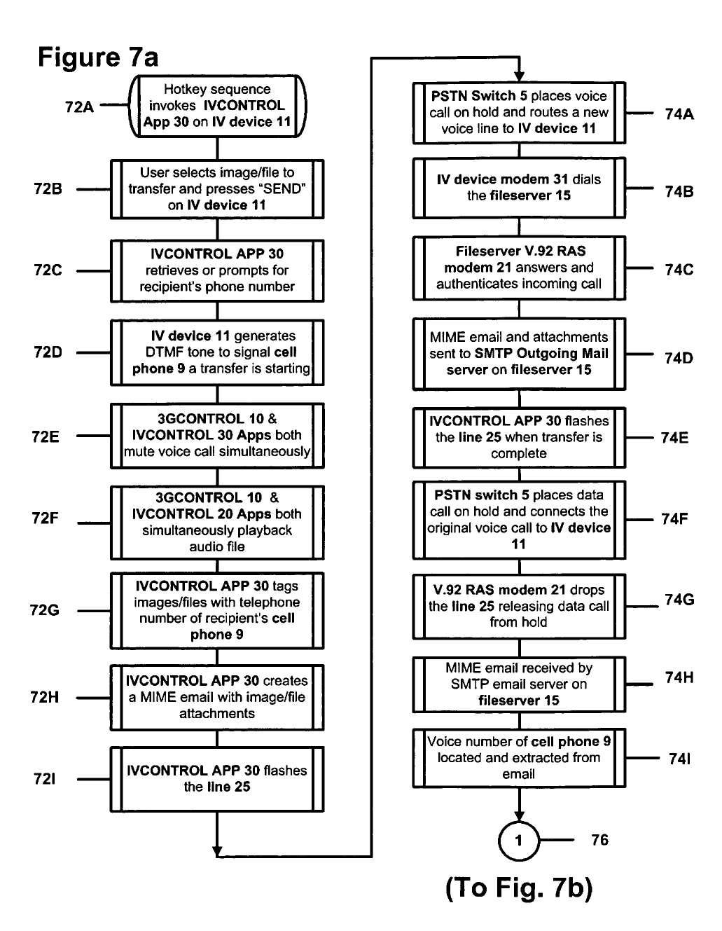

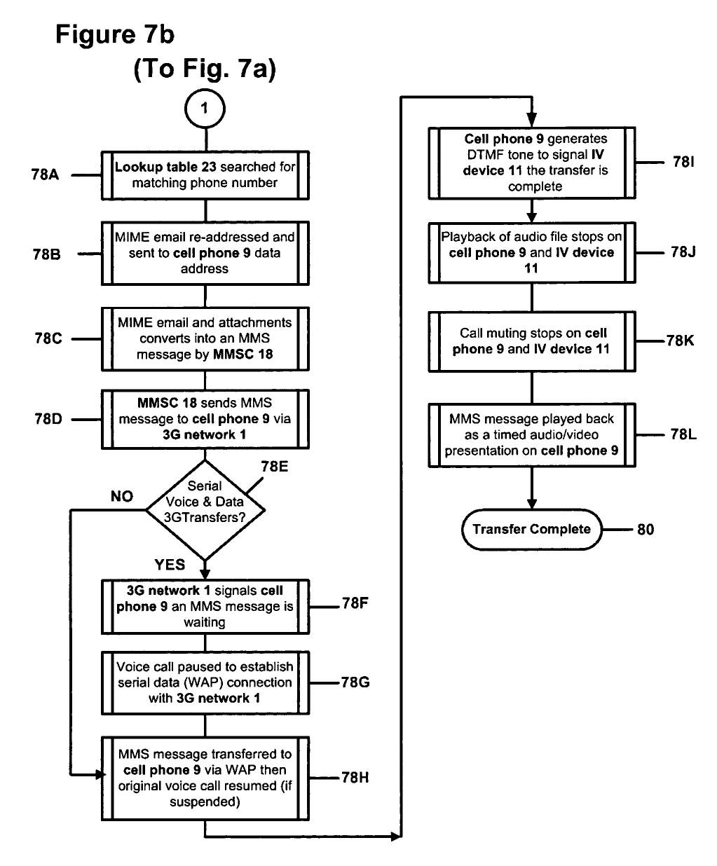

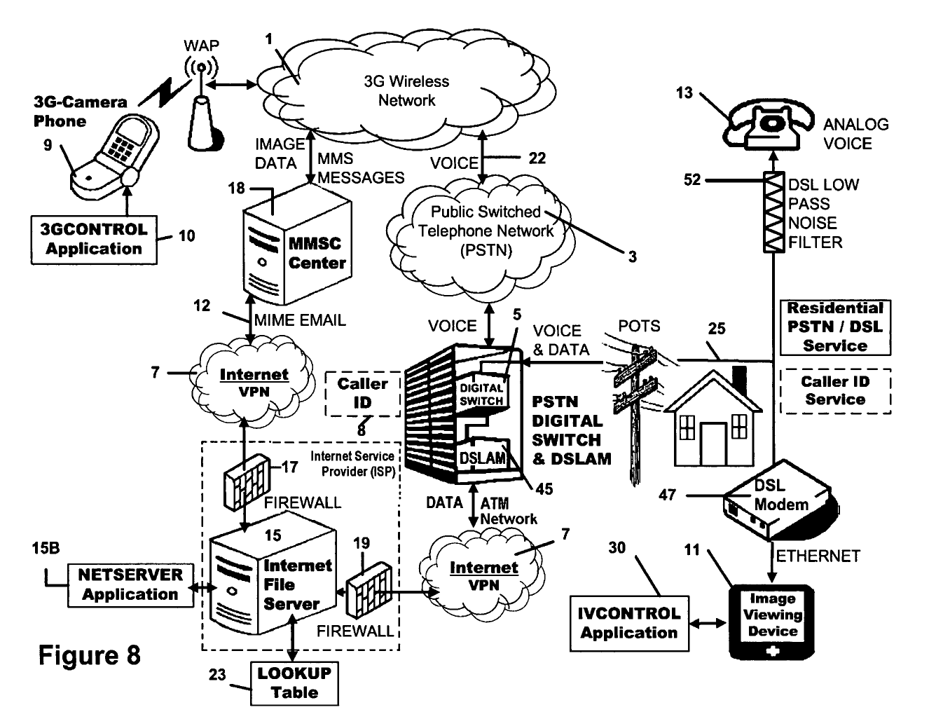

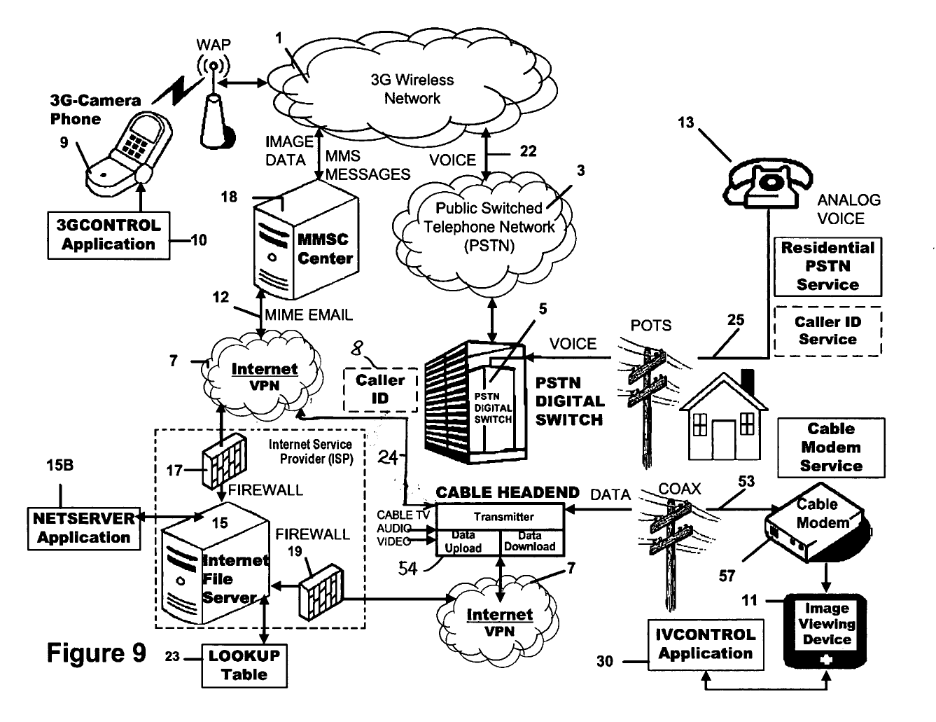

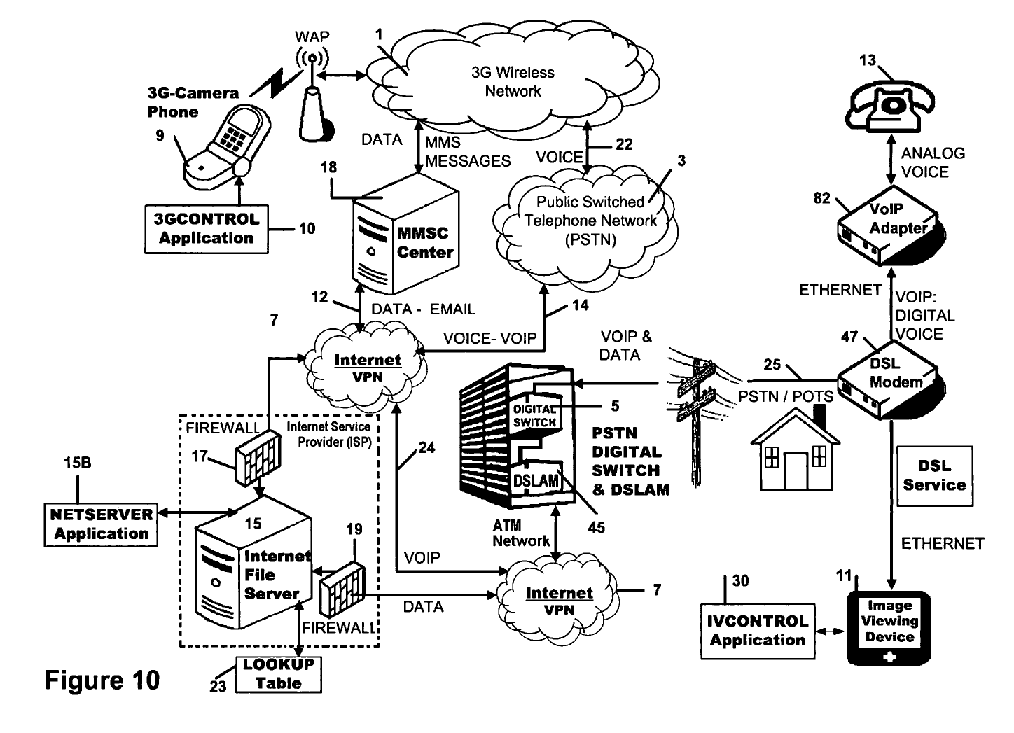

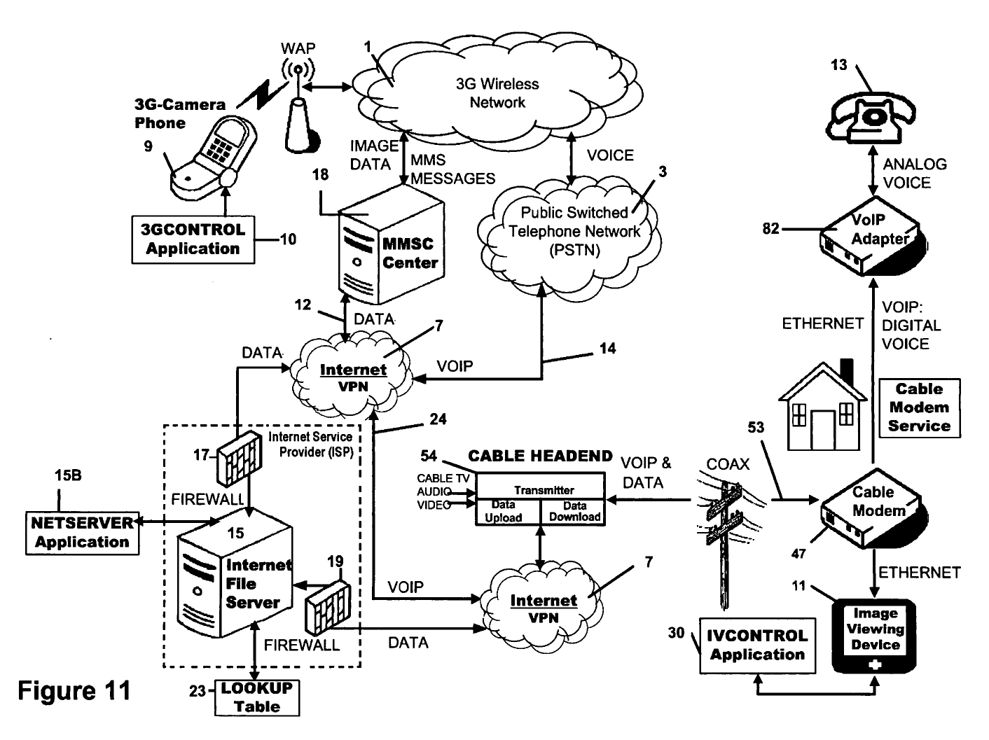

The IVCONTROL application determines and applies the appropriate information to the Image Viewing Device 11 and applies that information to lookup table 23 when the image viewing device is powered up. That initialization procedure is illustrated in the flow chart of FIGS. 5A and 5B to which reference may be made. As there described in boxes 60A through 60D, the application starts, retrieves the hardware number, such as the serial number of CPU 27, and prompts the user for the phone number and the kind of data connection, narrowband or broadband and starts a five minute timer. If the connection is broadband, the IVCONTROL application follows steps 69A through 69C, 71A through 71e, 73 and 75, which encompasses the creation of an email addressed to the fileserver with information on the hardware Identification, voice telephone number, and broadband connection. That is followed by the NETSERVER application creating and assigning a new email address, creates the lookup table 23 with entries for voice number, email address, user hardware Identification and the device type.

If the connection was narrowband and the IVCONTROL application branched to the left at step 60E, the IVCONTROL application dials the fileserver and establishes an analog modem data connection (61 A), sends the hardware identification, telephone number and connection information to the NETSERVER application 15B (61B), creates a unique email address based on the hardware ID (61C) and reserves that number for future exclusive use by the image viewing device (63A and 63B) and creates the lookup table 23 with entries for voice number, data address (using the voice telephone number), user hardware Identification and the device type. Once the table update is checked for correctness (63D) the application dials image viewing device 11 to confirm the update. If the foregoing is not completed before the timer times out (65), the process is repeated over commencing at 60A. Otherwise stage 67 is attained and the set up is completed.

The IVCONTROL application, for example, updates the lookup table 23 on the fileserver whenever the voice or data connection to image viewing device 11 changes. If the IVCONTROL application detects a the data connection has changed, or the user manually informs the program a change has occurred, the IVCONTROL application performs a simple registration process that prompts the user to specify the image viewing device data connection (e.g. narrowband or broadband) along with the PSTN or VoIP telephone number associated with the image viewing device If the IVCONTROL application on the image viewing device informs the NETSERVER application on fileserver 15 that a narrowband data connection is being used, the NETSERVER application updates the lookup table by storing the PSTN telephone number as both the voice number entry and the data address entry of the image viewing device. If, however, the IVCONTROL application informs the NETSERVER application that a broadband Internet data connection is being used, the NETSERVER application updates the lookup table by storing the PSTN or VoIP telephone number as the voice number entry and then assigns a private email address as the data address entry. The assigned email address is checked against all previously assigned email addresses, and, if a conflict is found, an alternate address is generated and then the checking process repeated until an previously unused email address is confirmed.

Since the data address for image viewing device 11 is a private email address that is assigned by the NETSERVER application 15B, that address is transparent to broadband users (e.i. DSL or CATV users). By using a system of private email addresses and email servers, data transfers to the image viewing device 11 can occur independently of existing broadband DSL or cableTV email accounts which greatly simplifies the installation, configuration, and operation of the system.

Returning to FIG. 1, as one appreciates, the system of FIG. 1 permits a 3G-camera phone to send an image on the PSTN network directly to a image viewing device associated with a residential telephone receiver, and a single telephone line. So while a voice call is in progress using the telephone, the voice call is automatically placed on hold, and then resumed, once the image is received at the image viewing device. Although the foregoing achievement is the principal benefit of the present invention, the invention is not restricted to the PSTN network, but is of more universal application. As becomes apparent, the new system is compatible with a telephone system that uses VoIP instead of the conventional narrowband PTSN POTS connection. Additional benefit is obtained by the ability to also use broadband DSL or CATV connections that reduce the amount of time a telephone is call placed on hold by increasing the maximum data transfer rate of the image transmission from 56K for narrowband PTSN POTS connections and up to 1.5 Mbps for broadband DSL and CATV connections.

As those skilled in the art appreciate, in some cases, a broadband DSL or CATV connection will even eliminate the necessity to place voice calls on hold if used in conjunction with newer 3G technology such as the CDMA2000EV-DV or WCDMA standards. When using broadband DSL or CATV connections, operation of the image viewing device 11 is essentially automatic and “hands-free”, giving the image transfer system a more universal utility. To obtain the additional utility offered by broadband connections, image viewing device 11 must be supplemented with an Ethernet port. Those additional features are described in the paragraphs that follow herein.

IMAGE VIEWER DEVICE—FEATURES OF A PRACTICAL EMBODIMENT. In FIG. 2, the elements of image viewing device 11 were presented in block form. The function of those elements and the functions carried out by the IVCONTROL application 30 of the image viewing device 11 were described in the preceding description of the operation of the new system. In a practical embodiment for that image viewing device of FIG. 2, the image viewing device preferably comprises an Intel compatible, x86 based CPU, WinPad-type computer that is customer configurable, uses low power, and is of such size and weight as to be considered mobile or portable. A suitable semiconductor processor chip 27 for the computer CPU is the AMD SC-1200 processor. The associated display 29 for a practical embodiment, preferably, is a 35.5 centimeter color active matrix display with minimum resolution of 640×480 and 256K colors, such as is commercially available from the NEC company as model NL 6448AC3318. The display includes a cold cathode fluorescent tube back light, not illustrated.

The joystick type user input device 35 is preferably a VaraPoint miniature joystick. The joystick is a commercially available input device and is specifically available from Varatouch Technology Incorporated using P/N VP1-001s. The VaraPoint joystick combines performance, reliability, and durability with low cost and ease of integration. VaraPoint is a mechanically simple, analog device based on variable resistance. That joystick is ideal for pointer control in graphical user interfaces and menus. The joystick device can be used with a variety of A/D converters, the associated circuitry requires a low part count, and is ideal for battery operated systems.

Image viewing device 11 is both AC and DC powered by power supply 39 or battery 39B. In AC mode, the image viewing device is powered using an AC/DC wall transformer, not illustrated, that outputs +5 Volts DC. In DC mode, a self-contained SMART Lithium Ion battery, 39B, housed within the image viewing device is recharged in place. Battery configurations that provide 1600 mAh (3 cell) that lasts approximately 3 hours and 3200 mAh (6 cell) that lasts approximately 6 hours are available. Optionally, a battery backup system may be included that uses standard AAA Alkaline cells as the backup power source to preserve Instant-on settings while swapping rechargeable batteries.

Secondary Storage internal (memory) 37B is defined as memory cards including CompactFlash Type I, CompactFlash Type II, IBM Microdrive, SmartMedia, Memory Stick, MagicGate Memory Stick, MultiMedia Card and Secure Digital. A single CompactFlash slot is used to support CompactFlash Type I, CompactFlash Type II, and IBM Microdrive cards. A single Multi-Connector slot is used to support SmartMedia, MultiMediaCard, Secure Digital, Memory Stick, and MagicGate Memory cards. The minimum memory size supported is 128 MB. Memory cards and sticks are commercially available storage devices and are available from multiple vendors.

The optional built-in microphone 38 and speaker 40 (together with appropriate electronic circuits, not illustrated) enables the image viewing device to also function as a speakerphone, if desired, in addition to the principal functions of the unit. The embedded speakerphone allows the unit to be used for phone calls should the home telephone 13 be unavailable.

USB On-The-Go port 32 is preferably built-in with a mini-A plug. The USB OTG port allows the image viewing device 11 to connect a PC or MAC with a USB port or to a USB printer. The USB OTG port also permits additional hardware to be attached to the image viewing device 11 as desired. For example, the USB OTG port can connect image capture devices such as scanners, digital cameras, webcams, and videophones among other devices. The USB OTG port can support up to 127 USB devices (using appropriate USB hubs).

PC parallel port adapter 34 is specifically designed to attach legacy printers with parallel port interface to the image viewing device. Using the parallel printer port, users can easily print out hard copies of their favorite image files to printers that are not equipped with USB ports.

Optional I/O jacks on the image viewing device include the “Mic-In” 38 input jack to connect to external microphones, an amplified “Earphone Out” jack 44 is used to connect to non-amplified external earphones/headphones/speakers, a non-amplified line out “Speaker Out” jack, not illustrated, may be included to connect to amplified audio speakers, the IRDA Infra Red port 36 is used to transfer image files or other types of binary files, such as MPEG4 audio/video files, and to other Infrared devices for storage and/or printing using a wireless connection. A “Video Out” jack 44 is mandatory for image viewing device implementations that utilize an external display, such as a large screen television monitor or computer monitor, in place of an embedded LCD. The “Video Out” jack 44 is used to display images on separate external large screen televisions as well as storing images an analog recording devices such as VCRs.

The image viewing device preferably supports both NTSC-M and PAL video formats and feature Composite, S-Video, and SCART connections. The NTSC-M video signal specification is 720×480@60 Hz and should implement a three-line flicker filter to ensure text and other images are displayed jitter free. The PAL video signal specification is 720×576@50 Hz and should support PAL-M/B/D/G/H/I.

Embedded Linux is preferred for the operating system (“OS”) 28 of the computer chip, CPU 27. Embedded Linux is able to boot from flash memory, is able to operate diskless, contains a scalable footprint down to 500 Kbytes, and has support for custom designs and embedded production form factors. The image viewing device application and applets are preferably written in Java, a standardized Java runtime environment combined with Java APIs. The image viewing device also incorporates the Java Mobile Information Device Profile (“MIDP”) combined with the Connected Limited Device Configuration (“CLDC”). This Java environment is specifically designed for today's mobile information devices (“MIDs”) such as phones and entry level PDAs. MIDP provides the core application functionality required by the image viewing device—including the user interface, network connectivity, local data storage, and application lifecycle management—packaged as a standardized Java runtime environment and set of Java APIs.

The IVCONTROL application 30 automatically (and silently) manages the transfer of images files, as well as other types of binary files, such as MPEG4 audio/video files, to and from image viewing devices that access the Internet. The IVCONTROL application loads when the operating system boots, runs as a background process, transparent to the user, and requires no user interaction, making the application very easy to use by those who are unfamiliar with the intricacies of computers.

IMAGE TRANSFER—3G-CAMERA PHONES TO DSL CONNECTED IMAGE VIEWING DEVICES. As earlier briefly noted, some telephone stations may DSL service available from the local telephone company. Broadband DSL technology permits the ordinary POTS telephone line, which is designed to carry voice signals in the audio frequency range, to simultaneously carry high frequency signals, essentially dividing the analog POTS telephone line into two frequency ranges (e.i. frequency multiplexing the telephone line). High frequency signals inaudible to the telephone user are used to transmit data and, therefore, are able to be transmitted simultaneously with the audible low frequency signals used for voice without producing interference with one another, even while the telephone user carries out a two-party voice communication on the telephone. The preferred embodiment is designed to ensure that broadband DSL users are able to have and use image viewing devices and transfer digital images from and to a 3G-camera phone.

Reference is made to FIG. 8, which is a block diagram of the system of FIG. 1 modified to include the additional equipment at the central office and the alternative equipment at the broadband DSL telephone station 13 required to integrate the broadband DSL system and the image viewing system of the present invention. For ease of understanding, elements of FIG. 1 that are repeated in this figure are identified by the same numeral used for those elements in FIG. 1. Elements that are the same in kind as in FIG. 1, but which are unique to the broadband DSL system, instead of the narrowband PTSN POTS system represented in FIG. 1, are assigned the same numeral and that numeral is primed. The PSTN telephone system 3 and central office digital switch 5 represented in FIG. 1, adapts to a broadband DSL option, for one, by including a DSLAM multiplexer 45, symbolically illustrated inside the central office 5. DSLAM 45 handles both incoming and outgoing data, incoming data transfers from the 3G-camera phone 9 and, as later described, outgoing data transfers to the 3G-camera phone. Email sent from fileserver 15 to the email address of the DSLAM 45 is delivered via Internet 7 and, more specifically, through a Virtual Private Network (“VPN”) on the Internet, earlier described, established to accommodate the preferred embodiment of the image transfer system. Internet data from the virtual private network enters the DSLAM 45 in a binary format (1/0) and exits the DSLAM in an inaudible audio format that is input into the digital switch 5 in the central office. In parallel, the audible audio signal carried on the PSTN line from the network 3 is input to the same switch. Digital switch 5 combines the audible (PSTN voice) and the inaudible (Internet data) audio signals and outputs the combined signal on the same telephone line 25, the existing twisted pair wire leads extending to the narrowband PTSN POTS telephone of the recipient.

The telephone station 13 of the broadband DSL user includes standard devices for receiving and handling the voice transmissions, such as telephone handsets 13 and facsimile machines, not illustrated, which all connect through a low-pass filter 52 to the user's narrowband PTSN POTS line 25. The image viewing device 11 interfaces through an integrated Ethernet port to a broadband DSL modem 47 that is directly connected to the same narrowband PTSN POTS line 25. A broadband DSL modem 47 is required to demodulate the inaudible high frequency signals (or, conversely, in the case of transmission in the reverse direction, converts the low frequency signals to high frequency signals). In the embodiment of FIG. 8, the telephone 13 and image viewing device 11 are connected in parallel to same narrowband PTSN POTS line 25, but essentially operate independently. As before, the function of the programming of the various components is revealed by the description of operation, which follows.

In so far as is visible to the user, the establishment of a voice call and the transmission of an image from the 3G-camera phone 9 is the same as described in connection with FIG. 1. However, the signal path within the telephone network differs slightly than before. To establish the initial call the 3G-camera phone user dials the call, sending thereby the DTMF dial tones into wireless network 1. The wireless network in turn accesses PSTN 3 and routes the connection to the local central telephone station of the user and DSLAM multiplexor 45, through digital switch 5, over narrowband PTSN POTS line 25, filter 52 to telephone 13. Once alerted, the user of telephone 13 may pick up and be told of the planned image file transmission.

The image viewing device 11 is powered on by the telephone user who plans to receive (or send) an image (e.g. an image file) over the phone lines 25. The preceding description of operation of FIG. 1 described the operation when the called user's telephone number is associated with a narrowband PTSN POTS type data connection to an associated image viewing device 11. With the user of FIG. 8, however, a check by NETSERVER application 15B of the telephone number of the called party (in lookup table 23 of fileserver 15) to whom the user of 3G-camera phone 9 intends to send an image (or images) results in a determination by the NETSERVER application 15B that the called party telephone number is associated with a broadband DSL type connection, a broadband connection, and secures the Internet email address of that broadband DSL user from the configuration information found in lookup table 23. Configuration information regarding the data connection associated with the voice number is manually entered by the user of telephone 13 as part of the setup process. Once entered, that information is permanently registered in the lookup table 23 until updated again by the user, if the connection is changes. The NETSERVER application routes the images, originally addressed to the receiving party's voice number, instead to the email address of the broadband DSL modem associated with the voice number. The message is passed through firewall 19 and routed through the virtual private network on the Internet 7 and, thence, to DSLAM 45 in the central telephone station. The use of the virtual private network guarantees that the email message will be delivered promptly to the intended recipient by taking the most direct path from fileserver 15 to the central station nearest to the residence of the called party telephone 13.

The email address leads to DSLAM multiplexer 45 (and indirectly to narrowband PTSN POTS line 25), which receives the digital email message and the attached image data at an input and feeds that data (as an inaudible high frequency signal) into the digital switch 5 of the nearest central office. In this image transfer system, multiplexer 45 receives digital data from the fileserver 15 and relays that data through the digital switch for transmission over the narrowband PTSN POTS line 25 to image viewing device 11 associated with both that narrowband PTSN POTS line and standard telephone 13. The mechanics of such an arrangement and the mode of operation are well known to those skilled in the telephone arts and are not particularly necessary to understand the operation of the invention. Accordingly, those details need not be presented here.

While data fed into the DSLAM is being output to digital switch 5, voice transmission, if occurring, is being fed concurrently into the same digital switch. Since voice transmission occurs in a separate frequency range than that used for the data transmission, referred to as frequency multiplexing, the two transmissions do not interfere with one another. As recalled from the description of 3GCONTROL application 10 of the 3G-camera phone, the 3G-camera phone temporarily places the voice call on hold, establishes a WAP data connection with the wireless provider 1, and then sends the image file to the email address of the fileserver 15. Upon receipt, NETSERVER application 15B routes the image file to the email address of the broadband DSL modem 45 via Internet email. The DSLAM 45, located at the telephone company central office, receives the image data over the VPN Internet addressed to the broadband DSL modem's email address and converts the data to an inaudible audio signal that is input in parallel with the audible PSTN voice call into the digital switch 5 connected to the broadband DSL user of telephone 13. The image and the voice call are simultaneously sent across the same narrowband PTSN POTS line 25 as audio signals to the broadband DSL user's telephone 13. The broadband DSL modem 47 at the user's telephone station converts the image file, transmitted as an inaudible audio signal, back to the original binary (1/0) data format, and then outputs that formatted binary data to image viewing device 11 via the Ethernet port.

Reference is again made to the diagram of the image viewing device 11 presented in FIG. 2. The image viewing device includes a built-in V.92 modem 31 to enable narrowband data connections that facilitate the transfer images or other files from the 3G-camera phone. The Ethernet port 16, and Ethernet functionality enables the image viewing device to function with broadband Internet data connections, permitting direct connection to either broadband DSL or cable modems.

The IVCONTROL application 30, stored locally on image viewing device 11, loads automatically when the image viewing device boots, and supports both narrowband and broadband configurations. Once loaded, the IVCONTROL application performs email, file transfer, and file printing functions, as well as diagnostic tasks. To transfer images, as well other types of binary files such as MPEG4 audio/video files, both to and from fileserver 15, IVCONTROL application 30 performs email functions. To receive images sent from a 3G-camera phone 9, the IVCONTROL application 30 connects to a POP3 email server on a remote Internet fileserver by connecting to port 110 of the remote fileserver using either the narrowband V.92 modem dial-up connection or broadband DSL or CATV Internet data connections. The IVCONTROL application supports narrowband and broadband data connections to remote SMTP email servers using port 25 of the remote computer system to send outgoing images to the target 3G-camera phone. For authentication purposes, an account name and account password must be entered to successfully transfer files to and from either the POP3 or the SMTP email server. Once authenticated, the image viewing device is able to receive binary files from any 3G-camera phone using the POP3 incoming email server and/or send binary files to any 3G-camera phone using the SMTP outgoing email server.

Returning to FIG. 8, unlike the narrowband PTSN POTS connection in which incoming email from the 3G-camera phone 9 is announced using call waiting, broadband connections do not use call waiting. However, broadband connections are always “live” and connected. That allows the IVCONTROL application 30 to constantly check the status of the remote POP3 incoming email server to determine if a new 3G-camera email or phone message was received and is waiting review. Upon detection of waiting email, IVCONTROL application 30 downloads the message to the image viewing device using the Ethernet port to connect to an external DSL or CATV modem. Once so downloaded, the IVCONTROL application opens the email message and any associated binary file attachments, in the manner previously described in connection with the embodiment of FIG. 1.

Outgoing messages (including image files) may be sent from image viewing device 11 to a 3G-camera phone 9 when the user presses the Transfer key on image viewing device 11. The IVCONTROL application 30 connects to a remote POP3 email server by addressing port 110 of the remote computer system using either a narrowband V.92 data connection or broadband Ethernet data connection. Upon pressing the Transfer key, IVCONTROL application 30 converts the user selected images or other files, such as MPEG-4 Audio/video clips, into a MIME formatted email message with binary file attachments. Depending on the configuration of the image viewing device, the MIME formatted email is then sent to a remote SMTP email server by either dialing a remote access modem using internal modem 31 in order to establish a narrowband data connection or by utilizing the existing always “live” broadband Internet data connection. The IVCONTROL application connects to the SMTP email server using port 25 of the remote computer, authenticates the connection, and then transfers the email to the SMTP email server on the remote fileserver. Once received, the NETSERVER application on fileserver 15 extracts the target 3G-camera phone telephone number from the MIME email, replaces the number with an MMS email address stored in lookup table 23 for that cellphone, and then forwards the message to the MMS email address via the Internet.

IMAGE TRANSFER—3G-CAMERA PHONES TO CABLE MODEM CONNECTED IMAGE VIEWING DEVICES. Telephone users of the traditional telephone network may alternatively subscribe to a cable modem system made available by the local CATV companies. The preferred embodiment of the invention ensures that those additional telephone users may receive transfer of a digital image from a 3G-camera phone. CATV, as it is known, refers to the coaxial cables, such as T1 or T5 lines, that are the transmission medium for the distribution of television signals. Those CATV lines are physically separate and distinct from the plain insulated wire pairs of the narrowband PTSN POTS telephone line supplied by the telephone company. Both CATV and narrowband PTSN POTS telephone lines terminate at a location within the home or business. Preferably those terminations are located in proximity to one another for convenience in using the present image transfer system.

Reference is made to FIG. 9, which is a block diagram of the additional equipment at the central office presented in FIG. 1 and the alternative equipment at the telephone user's station required for the CATV application and the image transfer system of the present invention. For ease of understanding, elements of FIG. 1 that are repeated in this figure are identified by the same numeral used for those elements that were used with FIG. 1. Elements that are the same in kind as in FIG. 1, but which are unique to the CATV user, instead of the narrowband PTSN POTS line user represented in FIG. 1, are assigned the same numeral earlier used, and that numeral is primed.

For voice connections the local carrier digital switch 5 at the central station is connected over the narrowband PTSN POTS line 25 to the standard telephone 13 at the user's premises, which is essentially the same arrangement that exists for the user in the system of FIG. 1. However, the cable modem system is typically located on the premises of a TV CATV video distributor, such as Time-Warner. The CATV system includes a CATV head end 54, a CATV head end transmitter 54 and coaxial CATV 53, which leads from the video distributor to the premises of the telephone user. That system is separate from the telephone company. A cable modem 57 is provided at the user's premises, in addition to the image viewing device 11 earlier described. For data transmission over the CATV system via the Internet 7, the CATV head end transmitter 54 contains a port for data uploads and another for data downloads, is coupled to the Internet 7, as was each of the telephone systems earlier described, and possesses a private email address.

The input port of cable modem 57 connects to one end of coaxial CATV 53 and another output port of that modem connects to image viewing device 11 via the Ethernet port of that image viewing device. The mechanics of the CATV arrangement and the mode of operation are well known to those skilled in the art of CATV networking and not necessary to an understanding of the present invention. Accordingly, those details are not discussed in detail. The connection of CATV head end 54 to the Internet allows email messages addressed to that termination system to be received and forwarded to the appropriate one of the addressed user stations, in this example, represented by cable modem 57.

By accessing the configuration information of the various telephone numbers of telephone stations 13 in the lookup table 23, NETSERVER application 15B determines the kind of telephone connection in use by image viewing device 11 at the respective telephone number of the called party. In brief in that way the image viewing device is determined to be connected to a CATV system. The configuration information also gave the Internet address for the cable modem 57 associated with telephone 13. The NETSERVER application then addresses the email to the Internet address of the cable modem 57 and sends the email. A portion of that address, e.g. the host address, is the address of CATV headend 54, and the email is routed through that CATV headend.

CATV head end 54, which is connected to Internet 7 via link 24 or, alternatively, from the fileserver 15 and the VPN, receives the digital email message and the attached image data at an input and sends that that data (as a high frequency signal) from the transmitter, located at the CATV service provider as digital data over CATV 53 to cable modem 57. The cable modem feeds into the Ethernet port and, thence, into image viewing device 11. Note that the cable modem 57 and the image viewing device 11 are located at the user premesis in proximity to standard telephone 13. The foregoing CATV system and mode of operation thereof are well known to those skilled in the CATV system arts and the details thereof are not particularly necessary to an understanding of the present invention. Accordingly, those details need not be described. cable modem 57 and CATV head end 54 are able to handle both incoming data transfers from the 3G-camera phone and, as later described, outgoing data transfers to the 3G-camera phone.

Since CATV line 53 is entirely independent of narrowband PTSN POTS telephone line 25, any voice transmission over the standard telephone may continue even while binary digital information is being fed down CATV 53. However, that is only theoretically possible, but not practicable. Recalling from the description of the 3G CONTROL application 10 loaded on the 3G-camera phone 9, 3GCONTROL application 10 places any voice call over the 3G-camera phone on hold, while the image data is being transmitted from the 3G-camera phone, and resumes the voice call only after the data has been sent. The cable modem 57 supplies the MMS message containing the image files to the Ethernet port of the image viewing device 11, which is active and is running an email application. As recalled, the image viewing device is basically a programmed general purpose PC dedicated to the image viewing device function described in this specification, and requires no special hardware expertise.

Broadband CATV and DSL connections use exactly the same method and applications to send and receive 3G-camera phone images. The image viewing device 11 directly connects to either a broadband DSL modem or cable modem using an optional on-board Ethernet port. The image viewing device runs an IVCONTROL application 30 that performs email, file transfer, and file printing functions, in addition to diagnostics. 3G-camera phone images are downloaded onto the image viewing device by accessing a POP3 incoming email server on the remote Internet fileserver. Images as well as other types of files such as MPEG-4 audio/video clips are uploaded from the image viewing device to the 3G-camera phone by accessing an SMTP outgoing email server on the remote Internet fileserver.

The NETSERVER application on the Internet fileserver 15 uses a lookup table to store the data address of each network device so message transfers to and from that network device can be routed properly. The 3GCONTROL application 10 running on the 3G-camera phone 9 and IVCONTROL application 30 running on the image viewing device 11 automatically receive the incoming email containing image files (or other content), storing the messages locally for display to the user. As described previously, the IVCONTROL application 30 performs one additional step of reassembling the email attachments into presentation containing audio, video, text, and timing information that mimics playback of the original MMS message on the 3G-camera phone.

IMAGE TRANSFER—3G-CAMERA PHONES TO VOIP USERS WITH DSL CONNECTED IMAGE VIEWING DEVICES. Reference is made to FIG. 10, which illustrates the system of FIG. 1 modified to incorporate the VoIP protocol for transmission of voice transmissions in the environment of a broadband DSL type connection for transmission of voice and data. The system of FIG. 10 contains many of the components of the broadband DSL system of FIG. 8, previously considered. In this embodiment broadband DSL modem 47 contains two outputs, one for connection of data files received over the narrowband PTSN POTS line 25 to the image viewing device 11, and a second for connection to the input of a VoIP adapter 82. The adapter functions to convert the digital voice signals output from modem 47 to the analog voice signal that can be converted to audible voice by telephone 13, to which the adapter output is connected. With the VoIP protocol, voice transmissions are sent over the internet as data. That transmission is in addition to the data transmissions, such as image data. Because the narrowband PTSN POTS line 25 is effectively frequency multiplexed, the telephone line is capable of handling two separate transmissions simultaneously. Therefore, there's no need for use of a call waiting feature for image transmission during the coarse of a telephone conversation when both the called party and the calling party use VoIP protocol. In this system the 3G-camera phone 9 sends voice messages over the 3G wireless network, and those voice messages, constituting audio, are converted to VoIP data packets at the 3G wireless network 1 by known equipment, not illustrated.

Those data packets are addressed to the telephone number of the standard telephone 13 by 3G-camera phone 9, which is the internet address of cable modem 47. That data travels over the internet 7, through the firewall 17, system fileserver 15, running NETSERVER application 15B, firewall 19, and the virtual private network on the internet 7 to the DSLAM45 at the central station. From there the voice and image data travels concurrently over line 25, through modem 47, to adapter 82 and image viewing device 11. The adapter converts the VoIP protocol back to the audible analog signal of the users voice. The foregoing briefly described transmission of digital binary image files in one direction. Transmission of images in the reverse direction essentially functions the same as presented in FIG. 8 and is not repeated.

IMAGE TRANSFER—3G-CAMERA PHONES TO VOIP USERS WITH CABLE MODEM CONNECTED IMAGE VIEWING DEVICES. Reference is made to FIG. 11 illustrating another mode of operation of the image transfer system of FIG. 10 in connection with VoIP in which transmission to the narrowband PTSN POTS telephone 13 and the image file transfer to the image viewing device 11 associated with that telephone is accomplished over a CATV system. One may wish to review the description of the CATV system operation described in connection with FIG. 9 before proceeding. In brief, dialing from 3G-camera phone 9, the 3G-camera phone user establishes a voice connection with telephone 13 via the Internet 7. VoIP connections are always eleven digits in length, including the area code. The 3G wireless network 1 receives the dial pulses, and, recognizing a telephone number, routes the pulses through the PSTN 3. The PSTN through an arrangement with the company that furnishes the VoIP system service, recognizes the access number as a VoIP and furnishes an email address. The PSTN then sends that address to the VPN of the internet 7 (via a link 14) and that routes a VoIP connection (via link 24) to the CATV head end transmitter 54 of the local central CATV service that provides CATV service to the user of telephone 13.

The transmitter then issues a digital signal that travels over coaxial line 53 to the modem 47, thence to the VoIP adapter 82 and finally to ringing the telephone 13. Assuming the user answers telephone 13, data packets of audio information are then sent by the 3G-camera phone user telling of the desire to send an image file, and a short conversation can be carried on bi-directionally. The foregoing is intended as a general summary as the operation of the telephone networks and VoIP protocol for normal conversation is outside the scope of the present invention.

The coaxial line 23 from the CATV head end transmitter 54 at the central CATV station supplies the voice and image data obtained over the virtual private network in the internet 7 to cable modem 47 at the CATV users residence. That data is appropriately routed as addressed between the VoIP adapter 82 and, thence, to telephone 13, and the Ethernet port to image viewing device 11.

As one appreciates, image viewing device 11 of FIG. 2 (and FIG. 3) is used in each and every image system described in this specification, necessitating at most minor change in the content of the IVCONTROL application 30, if any. The IVCONTROL application may contain routines for handling operation of the narrowband PSTN POTS data connection, broadband DSL and CATV Internet data connections as well as the broadband VoIP configurations and in the initial step of operation make a determination regarding the image viewing device installation, and then initiate the appropriate programming for operation with the system so determined.

The VoIP protocol is represented by promoters as a way to send real-time bidirectional communication of voice between two users who both have VoIP protocol capability without using the telephone company, that is, avoiding the telephone company toll charges and the inevitable state and federal taxes, charges and pass-through charges. However, where one of the users to the communication must use one of the telephone networks that user will incur a charge.

FLOW CHART—3G-CAMERA PHONE TO IMAGE VIEWINGDEVICE. As earlier noted, the preferred embodiment is designed to permit the transfer of image data from a 3G-camera phone to an image viewing device 11 that is associated with any narrowband PTSN POTS line, broadband DSL or CATV line. To achieve such communication, 3GCONTROL application 10 performs the sequential steps earlier briefly described and that follow in greater detail. The steps previously described are considered together with the steps listed in the flow chart of FIGS. 6A and 6B presented in blocks 62A through 62N, 64A through 641, 66A through 66N, and 68 which collectively ensure an adequate description of the application.

A1) The 3GCONTROL application 10 is stored in the non-volatile memory of the 3G-camera phone 9 and automatically loaded every time the 3G-Camera phone 9 is turned on. Once loaded, the 3GCONTROL application 10 runs silently in background until it is brought active by a shot key“sequence entered by user.

B1) The 3GCONTROL application permits the user to browse locally stored images on the 3G-camera phone and select the desired images to send to the image viewing device. After selecting the desired images to send, the application requests the user to select to send the selected images immediately or wait until a later point in time.

C1) The 3GCONTROL application 10 on the 3G-camera phone 9 captures the phone number of the last voice call received (assuming the telephone system and user have Caller ID service) or dialed. If the voice number of the last call received is private or blocked, the 3GCONTROL application 10 prompts the user to manually enter the voice number of the other party.

D1) The 3GCONTROL application uses a DTMF tone sequence to signal the IVCONTROL application on the image viewing device that images or other binary files are in the process of being sent. Upon transmitting the DTMF tone sequence, the 3GCONTROL application immediately begins to execute a pre-programmed set of instructions (muting the call, etc). Upon hearing the DTMF sequence, the IVCONTROL application begins to execute an identical set of instructions in unison resulting in both units operating in a synchronized manner.

E1) The 3GCONTROL application on the 3G-camera phone and IVCONTROL application on the image viewing device each simultaneously mute the voice call.

F1) The 3G-camera phone, through use of the 3GCONTROL application, and image viewing device, through use of the IVCONTROL application, both simultaneously start playback of the same audio file containing pre-recorded messages, tones, or music. The same audio file is locally stored on each device and is synchronized to play back in unison on both the 3G-camera phone and image viewing device.

G1) When sending images or other binary files, such as MPEG4 audio/video clips, the 3GCONTROL application tags the selected binary files with the voice number of the image viewing device (the receiving party) which serves as the destination address.

H1) The 3GCONTROL application determines the capabilities of the phone's 3G connection by referencing a variable previously stored in the memory of the 3G-camera phone by the 3GCONTROL setup process. Since the features and functionality of 3G networks can vary greatly, the stored variable is used by the 3GCONTROL application to determine the communication capabilities of the 3G-camera phone's specific 3G network. For example, if the variable indicates a CDMA-20001xRTT network (e.g. Sprint PCSVIsion), then simultaneous voice and data transfers are not possible, and as a result, a serial transfer method must be used instead. Conversely, if the variable indicates a UMTS network (e.g. AT&T mMode), then simultaneous voice and data transfers are possible.

I1) If the variable indicates a serial network connection, the 3GCONTROL application must pause the voice connection in order to establish a data connection with the 3G network. For example, if the variable indicates a CDMA-20001xRTT network (Sprint), then only serial voice and data transfers are supported. However, if the variable indicates a simultaneous network connection, the 3GCONTROL application does not need to pause the voice connection in order to enable data transfers with the 3G network. For example, if the variable indicates a UMTS network (AT&T mMode), then simultaneous voice and data transfers are supported.

J1) The 3GCONTROL application establishes a WAP data connection with the 3G network in order to transfer the images or other types of files.

K1) The 3GCONTROL application creates a single MMS message containing up to ten individually tagged image files, and then addresses the MMS message to the POP3 incoming email server on the network fileserver. Once addressed, the 3GCONTROL logs onto the POP3 email server on remote fileserver 15 by authenticating access with a user name and password. Once authenticated and logged onto the fileserver, the 3GCONTROL application sends the MMS message the email server on the remote fileserver.

L1) To provide security for sensitive messages or images, message encryption can be applied to the MMS message as an optional step (not shown in flowchart) before transmittal. To perform encryption, the 3G-camera phone user (sender) assigns a password to each MMS message. To open and view the message contents, the image viewing device recipient decrypts the message by entering the user assigned password.

M1) Upon sending the MMS message to the fileserver 15, the 3GCONTROL application terminates the data connection with the 3G network and releases the original voice call from hold.

N1) Upon exiting the 3G network and entering the Internet, the original MMS message sent from the 3G-camera phone is automatically converted into a MIME formatted email with binary file attachments by the 3G network's Multimedia Messaging Service Center (MMSC).

O1) The original MMS message, converted to a MIME email with binary file attachments by the MMSC, is received by the POP3 incoming email server on fileserver 15 which immediately indicates a message is waiting.

P1) The NETSERVER application 15B opens the waiting message and parses the message contents searching for the voice number of the image viewing device tagged to the files by the 3GCONTROL application.

Q1) The NETSERVER application locates the voice number of the image viewing device and extracts it from the message.

R1) The NETSERVER application searches the lookup table for the voice number of the image viewing device extracted from the message.

S1) If the voice number of the image viewing device can not be located in the lookup table, the NETSERVER application assumes a narrowband data connection and uses the voice number for the data address by default.

T1) If the voice number of the image viewing device can be located in the lookup table, the NETSERVER application extracts the data address associated with the voice number from the lookup table. Upon extracting the data address from the lookup table, the NETSERVER application replaces the original voice number associated with the associated data address extracted from the lookup table and then forwards the MIME email to the new address.

U1) If the image viewing device of the recipient uses a narrowband PTSN POTS connection, then voice number and the data address in the lookup table 23 use the identical telephone number. To forward the MIME email and attachments to a narrowband PTSN POTS connection, the NETSERVER application dials the telephone number of the image viewing device using the V.92 modem bank 21 directly connected to the Internet fileserver.

V1) The PSTN call waiting service signals the image viewing device that an incoming call is occurring by using a call waiting tone. Once the image viewing device detects the call waiting tone, the IVCONTROL application flashes the telephone line 25 which effectively suspends the original voice call by placing it on hold using the PSTN digital switch and enable the image viewing device to establish a data connection with the remote fileserver modem by using its internal V.92 modem to answer the incoming data call.

W1) The NETSERVER application authenticates the data connection and logs onto the image viewing device by entering a user name and password when queried by the IVCONTROL application.

X1) Once logged onto the image viewing device, the NETSERVER application sends the waiting email from the POP3 incoming email server on the fileserver 15 to the IVCONTROL application running on image viewing device 11.

Y1) Upon successful transmission of the email, the IVCONTROL application flashes the telephone line 25 effectively resuming the original voice call by removing it from hold and placing the data call on the second line on hold instead.

Z1) The dialing modem located at remote fileserver 15 (automatically) terminates the data call, on hold at the PSTN digital switch, by dropping the telephone line effectively terminating the connection.

AA1) The IVCONTROL application uses a DTMF tone sequence to signal the 3GCONTROL application on the 3G-camera phone that the images or other binary files were successfully sent. Upon transmitting the DTMF tone sequence, the IVCONTROL application immediately begins to execute a pre-programmed set of instructions (muting the call, etc). Upon hearing the DTMF sequence, the 3GCONTROL application begins to execute an identical set of instructions in unison resulting in both units operating in a synchronized manner.

AB1) The 3G-camera phone, through use of the 3GCONTROL application, and image viewing device, through use of the IVCONTROL application, both simultaneously stop playback of the same audio file containing pre-recorded messages, tones, or music. The same audio file is locally stored on each device and is synchronized to stop playback in unison on both the 3G-camera phone and image viewing device.

AC1) The 3GCONTROL application on the 3G-camera phone and IVCONTROL application on the image viewing device simultaneously stop muting the voice call.

AD1) The IVCONTROL application organizes the binary MIME email attachments into a timed audio/video presentation that mimics MMS playback using a 3G-camera phone.

FLOW CHART—IMAGE VIEWING DEVICE TO A 3G-CAMERA PHONE. The foregoing text presented the operation sequence when the system was used to transfer image files from the 3G-camera phone to the image viewing device 11 associated with individual telephone users of the PSTN system, when the image viewing device is located on a narrowband PTSN POTS line, a broadband DSL line or on the coaxial cable of a CATV system. To ensure the greatest versatility for the system, transmission in the reverse direction is also desired. As example, an image file produced by a separate 35 mm digital camera may be uploaded by the telephone user onto the image viewing device 11 and stored in memory 37B (FIG. 2). The user of that image viewing device may desire to send a copy of that image file to a person who is using a 3G-camera phone so that the user may view the picture on the LCD panel of his or her phone.

To achieve that two-way data communication, it is necessary for the image viewing device to contain extra capability and interactivity therein, much like that earlier described for image transfers from the 3G-camera phone, to the image viewing device. In accordance with the foregoing, an embodiment of an image viewing device for such a two-way transmission of binary data performs sequential steps as prescribed by the programming that is presented in the following paragraphs. As becomes apparent, many of the initial steps repeat operations carried out by the 3GCONTROL application 10, earlier described. The foregoing steps are considered together with the steps listed in the flow chart of FIGS. 7A and 7B presented in blocks 72A through 72I, 74A through 74I, 78A through 78L and 80, which collectively describe the steps or algorithms.

A2) The IVCONTROL application 10 is stored in the non-volatile memory of the image viewing device 11 and automatically loaded every time the image viewing device is turned on. Once loaded, the 3GCONTROL application 10 runs silently in background until it is brought active by a “hot key” sequence entered by user.

B2) The IVCONTROL application 10 permits the user to browse locally stored images on the image viewing device 11 and select the desired images to send to the 3GCamera phone 9. After selecting the desired images to send, the IVCONTROL application 10 can send the images immediately or wait until a later point in time to transmit.

C2) The IVCONTROL application 10 on the image viewing device 11 captures the telephone number of the last voice call received by the telephone handset sharing the line (requires Caller ID service) or the last telephone number dialed by the telephone handset sharing the line. If the voice number of the last call is private or blocked, the IVCONTROL application 10 prompts the user to manually enter the voice number of the recipient's 3GCamera phone into the image viewing device.

D2) The IVCONTROL application uses a DTMF tone sequence to signal the 3GCONTROL application on the 3G-camera phone that images or other binary files are in the process of being sent. Upon transmitting the DTMF tone sequence, the IVCONTROL application immediately begins to execute a pre-programmed set of instructions (muting the call, etc). Upon hearing the DTMF sequence, the 3GCONTROL application begins to execute an identical set of instructions in unison resulting in both units operating in a synchronized manner.

E2) The IVCONTROL application 10 on the image viewing device 11 and the 3GCONTROL application 10 on the 3G-camera phone 9 both simultaneously mute the voice call.

F2) The image viewing device, through use of the IVCONTROL application, and the 3G-camera phone, through use of the 3GCONTROL application, both simultaneously start playback of the identical audio file containing pre-recorded messages, tones, or music. The same audio file is locally stored on each device and is synchronized to play back in unison on both the 3G-camera phone and image viewing device.

G2) When sending images or other binary files such as MPEG4 audio/video clips, the IVCONTROL application tags the files selected by the user with the voice telephone number of the 3G-camera phone (the receiving party) which serves as the destination address.

H2) The IVCONTROL application creates an email message attaching up to ten individually tagged images or other types of files and then addresses the email message to the SMTP outgoing email server on the network fileserver.

I2) To provide security for sensitive messages or images, message encryption can be applied to the email message as an optional step before transmittal. To perform encryption, the image viewing device user (sender) assigns a password to each email message with attachments. To open and view the message contents, the 3G-camera phone recipient decrypts the message by entering the user assigned password.

J2) If the image viewing device uses a narrowband PTSN POTS data connection, the IVCONTROL application flashes the telephone line in order to activate the call waiting feature, and by doing so, places the original voice call on hold and routes an available voice line to the image viewing device as indicated by the dial tone.

K2) Upon detecting a dial tone indicating the presence of an outside telephone line, the IVCONTROL application instructs the internal V.92 modem used by the image viewing device to dial the remote access number of the remote Internet fileserver and establish a data connection.

L2) The IVCONTROL application authenticates access to the email servers by entering a user account and password when queried by the NETSERVER application running on the remote Internet fileserver. Once authenticated and logged onto the Internet fileserver, the IVCONTROL application on the image viewing device sends the outgoing MIME emails to the SMTP outgoing email server located on the remote Internet fileserver.

M2) Upon successfully sending the email, the IVCONTROL application flashes the telephone line 25 removing the original voice call from hold and bringing it active by and placing the modem data call on the second line on hold instead.

N2) The MIME email and attachments sent by the image viewing device is received by the SMTP outgoing email server on the remote Internet fileserver 15 which immediately indicates a message is waiting.

O2) The NETSERVER application 15B opens the waiting message and parses the message contents searching for the voice number of the 3G-camera phone tagged to the files by the IVCONTROL application.

P2) The NETSERVER application locates the voice number of the 3G-camera phone and extracts it from the message. Once extracted from the message, the NETSERVER application searches the lookup table for the voice number.

Q2) Upon locating the 3G-camera phone voice number within the lookup table, the NETSERVER application extracts the data address associated with the voice number from the lookup table. Upon extracting the data address (typically an email address) from the lookup table, the NETSERVER application replaces the original 11 digit voice target address with the extracted data address and forwards the message to its new destination.

R2) Upon entering the 3G network and exiting the Internet, the original MIME email and attachments sent from the image viewing device is automatically converted into a single MMS message by the 3G network's Multimedia Messaging Service Center (MMSC).

S2) The V.92 RAS modem located at the remote Internet fileserver releases the data call on hold at the phone company's digital switch by terminating the call by dropping the phone connection. If the image viewing device uses a broadband DSL or CATV connection, the IVCONTROL application automatically transfers the MIME email from the image viewing device to the remote Internet fileserver using the optional Ethernet port for connecting the image viewing device to broadband DSL or cable modem connections.

T2) The IVCONTROL application authenticates system access by entering a user account and password when queried by the NETSERVER email subroutine running on the fileserver. Once authenticated and logged onto the fileserver, the IVCONTROL application sends the outgoing email to SMTP outgoing email server on the fileserver.

U2) The email and its attachments are received by the SMTP outgoing email server on the fileserver and immediately parsed by the NETSERVER application in order to extract the 3G-camera phone voice number tagged to files by the image viewing device.

V2) The NETSERVER application locates the data address associated with the 3G-camera phone voice number by using a lookup table on the fileserver. Upon locating the data address associated with the voice number in the lookup table, the NETSERVER application replaces the 3G-camera phone voice number with the associated data address from the lookup table and then forwards the email onto the replacement data address.

W2) The NETSERVER application uses the SMTP outgoing email server to send the email from the remote Internet fileserver to the data address of the 3G-camera phone.

X2) The MIME email and attachments sent from the SMTP Internet server exits the Internet and the enters the 3G network through the 3G MMSC which automatically converts the email and attachments into a single MMS message in real-time.

Y2) The 3G network notifies the 3GCONTROL application running on the 3G-camera phone that an MMS message is incoming. Upon notification, 3GCONTROL application determines the capabilities of the 3G-camera phone's wireless connection by referencing a variable previously stored in the memory of the 3G-camera phone by the 3GCONTROL setup process.

Z2) If the variable indicates a serial network connection, the 3GCONTROL application must pause the voice connection in order to establish a data connection with the 3G network. For example, if the variable indicates a CDMA-20001xRTT network (e.g. Sprint PCSVision), then only serial voice and data transfers are supported. However, if the variable indicates a simultaneous network connection, the 3GCONTROL application does not need to pause the voice connection in order to enable data transfers with the 3G network. For example, if the variable indicates a UMTS network (AT&T mMode), then simultaneous voice and data transfers are supported and the MMS message will be automatically received.

AA2) Upon receiving the MMS message from the 3G network, the 3GCONTROL application terminates the data connection with the wireless provider and releases the voice call from hold (if necessary).

AB2) The 3GCONTROL application uses a DTMF tone sequence to signal the IVCONTROL application on the image viewing device that the images or other files were received.

AC2) The 3G-camera phone, through use of the 3GCONTROL application, and image viewing device, through use of the IVCONTROL application, both simultaneously stop playback of the same audio file containing pre-recorded messages, tones, or music. The same audio file is locally stored on each device and is synchronized to stop playback in unison on both the 3G-camera phone and image viewing device.

AD2) The 3GCONTROL application on the 3G-camera phone and IVCONTROL application on the image viewing device simultaneously stop muting the voice call.

AE2) The 3GCONTROL plays back the MMS message on the 3G-camera phone.

3G WIRELESS TECHNOLOGY—STRUCTURAL VARIATIONS. The image viewing device currently supports wireless providers implementing any of the following wireless technologies: CDMA2000 1x, CDMA2000 EV-DO, CDMA2000-EV-DV, EDGE (GSM), or WCDMA (UMTS). The capability to send or receive images, as MMS messages, while continuing the original voice conversation, or temporarily placing on the call on hold, is supported in differing ways by all 3G technologies. The image viewing device component of the present system is compatible with 3G-camera phones capable of transmitting voice and data either simultaneously or serially (e.g. suspending the voice call, sending data, and then resuming the voice call). The image viewing device component of the present system is compatible with 3G-camera phones capable of transmitting voice and data either simultaneously or serially (e.g. suspending the voice call, sending data, and then resuming the voice call). The image viewing device supports any GSM-or CDMA-based wireless phone/network that meets these minimum requirements regardless of the 3G-camera phone make or model or the 3G wireless service provider. Compatible CDMA systems can implement any single 3G CDMA technology or combination of technologies ranging from the latest CDMA CDMA2000EV-DV technology capable of simultaneous high data rate voice and data transmission to dual CDMA mode systems that combine legacy 1x technology for voice with the higher data rate EV-DO technology for data to legacy 1x technology that multiplexes voice and data together enabling simultaneous low data rate voice and data transmission. Compatible GSM systems can implement either GSM Class A or Wideband CDMA (UMTS) technology which are both capable of simultaneous voice and data transmission.

3G-CAMERA PHONE STRUCTURAL VARIATIONS The image viewing device supports image transfer to 3G-camera phones implementing the following minimum feature set: a color display to review images; local memory on the handset to stores still images; Multimedia Messaging Service capability including Internet and email and the capability to download and run a third party application.

3GCONTROL PROGRAM—FUNCTIONAL VARIATIONS The 3GCONTROL application may have multiple structural variations that can range from a simple menu driven interface to an intuitive graphical user interface that can be custom configured by users. The application code can be written in any language appropriate for 3G-camera phones, including, but not limited to Java2 Micro Edition (“J2ME”), Binary Runtime Environment for Wireless (“BREW”), Symbian Ul, and Microsoft Visual Studio.NET among others. The 3GCONTROL application may have variations that range from a simple single function implementation that is able to send only a single image at a time to a single user to a multiple function implementation that performs all necessary imaging functions, including sending and receiving images, support for multiple image recipients, and the capability to resize and enhance images. Depending on the distribution model, the 3GGCONTROL application can be downloaded from the wireless provider's website, or a third party website, for a fee or free of charge. The distribution method for the application code uses the wireless provider's existing distribution website currently used to distribute ringers, screens savers, games, and other binary files. For those existing users who have already downloaded the application, or purchased handsets with the application pre-installed by the wireless service provider, the distribution website also serves as a mechanism to distribute bug fixes or feature enhancements.

FILE ENCRYPTION & DECRYPTION FUNCTIONALITY. Although the principal purpose of the present invention is to provide an image that is visible to a telephone user at a remote location using conventional media or picture display programs on the image viewing device, it is also within the scope of the invention to send a binary file that might not be so easily readable or which may not even be an image file. As example, it is possible to modify a wireless phone to include, that is, integrate, a special encryption application into the handset that is able to scramble a JPEG image file, producing a scrambled JPEG file, also a binary file. At the receiving telephone station the station would be required to have the companion decryption technology and “key” provided by the sender to unscramble the file to restore the original media display or picture display readable file so that the file can be opened by conventional picture display programs. Such could be a computer application, the exact purpose of which or application is not immediately apparent to the inventor. In that instance, the binary file is simply sent, and saved or stored at the receiving end. That file would not be directly opened and displayed on the LCD panel screen. It is believed that skilled persons having read and understood the present invention may develop such applications.

FILESERVER—STRUCTURAL VARIATIONS. The network fileserver supports point-to-point transmission (A-B) and multipoint transmission (A-B, A-C, A-D, etc). Point-to-Point mode is used to send images and/or binary files from a single user to another single user and is used during two party telephone conversations. Multi-point mode is used to send images and/or binary files from a single user to two or more users and is used during conference calls with three more participants. The multi-point mode includes simultaneous and staggered delivery options. The simultaneous delivery option delivers the source images, or other binary files such as MPEG4 audio/video files, simultaneously to two or more receiving parties. The staggered delivery option delivers the source images, or other binary files such as MPEG4 audio/video files, sequentially to two or more receiving parties, one party at a time, with a customizable delay between each transmission. To transfer files between the 3G-camera phone to the image viewing device, the network fileserver uses high speed Internet connection, such as a T1 or T3 line, and a bank of V.92 compatible RAS modems.

Structural variations for the network fileserver from a cluster of servers in one geographic location to individual fileservers located in multiple geographically diverse locations. The high speed Internet connection may include a single T1 line, T3 line, or any combination of the two.

FIREWALL—STRUCTURAL VARIATIONS. A network firewall is implemented to prevent unintended harmless emails such as spam, as well as harmful emails such as Trojans and viruses, well as harmful emails such as Trojans and viruses, from entering the server. Structural variations for the network fileserver firewall can include any of the following structural implementations:
A. Packet filtering—Packets (small chunks of data) are analyzed against a set of filters. Packets that make it through the filters are sent to the requesting system and all others are discarded.
B. Proxy service—Information from the Internet is retrieved by the firewall and then sent to the requesting system and vice versa.
B. Stateful inspection—A newer method that doesn't examine the contents of each packet but instead compares certain key parts of the packet to a database of trusted information. Information traveling from inside the firewall to the outside is monitored for specific defining characteristics, and then incoming information is compared to these characteristics. If the comparison yields a reasonable match, the information is allowed through. Otherwise, it is discarded.

STRUCTURAL VARIATIONS OF THE MODEMS. To minimize the transfer time of binary files, both the network fileserver 15 modem bank as well as the image viewing device 11 implement V.92 compatible RAS modems. The RAS V.92 type modem is used to transmit binary files to or from the image viewing device 11 using standard narrowband PTSN POTS lines. Due to several enhancements incorporated within the V.92 ITU standard, use of V.92 based modems significantly minimizes the length of time required to establish an analog connection and transfer data between the network fileserver and image viewing device. During the hand-shaking procedure, the modem tests the communication link to determine the telephone line characteristics to that particular telephone number, which translates to selecting a transmission speed appropriate for those characteristics. With the V.92 standard, the length of time required to perform a modem handshake is reduced up to 50% from approximately 25 seconds to 12 seconds over earlier standards. To perform faster handshakes, V.92 modems are programmable. The modems remember the communication characteristics of the narrowband PTSN POTS line associated with each telephone number and store these values for later usage when the telephone number is again called, instead of retesting the communication link. To perform faster file transfers, V.92 modems also boost upstream data rates to 48 Kbps for transfer of large files and email attachments. Functional variations for the V.92 modem bank include accessing the modem bank by dialing a various local toll numbers, various local toll feel numbers, a single toll number, or a single toll free number.

FUNCTIONAL VARIATIONS OF CALL WAITING. To transfer files to and from callers using a single narrowband PTSN POTS line, the image viewing device utilizes the “call waiting” service. Functional variations of the “call waiting” service that can used in addition to standard call waiting include “enhanced call waiting” as well as “call waiting options”. These enhanced call waiting services/options perform the basic call waiting function plus additional new functions such as:

Drop1st—Ends the current call and answers the new call.

HoldMsg—Sends the new caller a pre-recorded message saying that the call will be answered in a moment. The new call is then put on hold until It can be answered.

Add2nd—Places both the current caller and the new caller on the line in a three-way conference call.

TakeMsg—Forwards the new caller to voice email or an answering service (if available).

IVCONTROL APPLICATION FUNCTIONAL VARIATIONS. The IVCONTROL application can have multiple functional variations ranging from a simple single function implementation that can only send or receive a single image to a multiple function implementation that can simultaneously send and receive multiple files to multiple email accounts. Other functional variations include the capability to reduce, enlarge, and enhance (brightness, contrast, redeye reduction, etc) bitmap images. Finally, the IVCONTROL application may include the capability to compress files before transmission and the capability to decompress files after receipt reducing the transmission period for certain file types such as uncompressed BMP images.

A question is addressed as to the meaning of placing a call “on-hold.” That term connotes that it is not possible to transmit any voice messages or other audio over the telephone line or connection so long as the call remains in that on hold condition, but that the connection or channel between the two telephones remains established (and may almost instantaneously be re-accessed when desired). It should be understood, however, that the invention is not limited to any particular technology by means of which the central office places a call on hold. Instead, what is significant to the invention is the effect and that effect is that the voice call is suspended or muted.

It may be recalled that reference was made to the term narrowband PTSN POTS as an acronym and the phrase “plain old telephone system” to refer to the multi-conductor telephone lines that extend from the PSTN telephone central office to the residential telephone at the PSTN users residence. Although multi-conductor lines have historically been used for that function, one recognizes that emerging technologies may make it feasible to change from that kind of telephone line to another, as example, a fiber optic line. Thus those insulated electrical conductor lines may in the future be replaced with optical fiber lines, and, of necessity, the internal electronics of the residential telephone set will change to include optical to electronic digital converters and the like. Should that occur, then that optical system will be considered as part of the plain old telephone system or narrowband PTSN POTS and the optical line is included and becomes the narrowband PTSN POTS line within the meaning of the present specification along with any older type of telephone line. Thus the invention should not be limited to the particular technology that as of the present time serves as the narrowband PTSN POTS system.

It is believed that the foregoing description of the preferred embodiments of the invention is sufficient in detail to enable one skilled in the art to make and use the invention without undue experimentation. However, it is expressly understood that the detail of the elements comprising the embodiment presented for the foregoing purpose is not intended to limit the scope of the invention in any way, in as much as equivalents to those elements and other modifications thereof, all of which come within the scope of the invention, will become apparent to those skilled in the art upon reading this specification. Thus, the invention is to be broadly construed within the full scope of the appended claims.

1. A 3G-camera phone for enabling wireless voice calls and wireless transfer of digital binary files over at least a wireless network, respectively, with a telephone and with a image viewing device associated with said telephone, respectively, during the course of a voice call, said 3G-camera phone comprises:
memory means for storing at least said digital binary image files;
dialing means for at least initiating establishment of a first telephone connection via at least said 3G wireless network to said telephone for conducting a voice call;
transfer key means, responsive to user actuation, for initiating a pause of said voice call, establishment of a data connection to said image viewing device and transmittal of at least one of said digital binary files to said binary file receiving device.

2. The 3G-camera phone as defined in claim 1, wherein said digital binary file comprises a digital image file and wherein said image viewing device comprises an image file-receiving device for receiving digital image files.

3. The 3G-camera phone as defined in claim 1, wherein said transfer key means further comprises means for momentarily breaking said first telephone connection (“flashing the line”).

4. The 3G-camera phone as defined in claim 2, further comprising: image selection means for enabling selection of at least one digital image file for transmission from said memory means to said image file receiving device.

5. The 3G-camera phone as defined in claim 3, further comprising: image selection means for enabling user selection of at least one stored digital binary file for transmission to said binary file receiving device.

6. The 3G-camera phone as defined in claim 1, wherein said 3G-camera phone further comprises: a keypad; a microphone, a speaker, an LCD panel, a programmed microprocessor, an RF transmitter, an RF receiver, a digital camera and a rechargeable battery.

7. The 3G-camera phone as defined in claim 4, further comprising:
image selection program means for enabling user selection of said one or more digital image files for transmission to said image file receiving device;
email preparing program means for preparing an e-email message containing as e-email message attachments one or more of said digital image files selected by said user; and
email transmittal program means for sending said e-email message.

8. The 3G-camera phone as defined in claim 7, wherein said email preparing program means, further comprises: addressing means for automatically addressing said e-email message with a predefined Internet address, said predefined Internet address being the Internet address of a private fileserver.

9. The 3G-camera phone as defined in claim 8, wherein said email transmittal program means further comprises: means for sending said email message to said first predefined Internet address.

10. The 3G-camera phone as defined in claim 8, wherein said telephone and said image viewing device are respectively accessed over the telephone line of a public switched telephone network (“PSTN”).

11. The 3G-camera phone as defined in claim 1, wherein said telephone and said binary file storage device are respectively accessed over the telephone line of a public switched telephone network (“PSTN”).

12. The 3G-camera phone as defined in claim 1, wherein said image viewing device includes: a digital image file receiving device for receiving digital binary files defining images.

13. The 3G-camera phone as defined in claim 12, wherein said telephone and said digital image file receiving device are respectively accessed over the telephone line of a public switched telephone network (“PSTN”) via separate ports of a broadband DSL modem.

14. The 3G-camera phone as defined in claim 2, wherein said telephone and said digital image file receiving device are respectively accessed over the telephone line of a public switched telephone network (“PSTN”); wherein said camera cellphone further comprises: a keypad; a microphone, a speaker, an LCD panel, a programmed microprocessor, an RF transmitter, an RF receiver, a digital camera and a rechargeable battery; and further comprising:
image selection program means for enabling user selection of said one or more digital image files for transmission to said digital image file receiving device;
email preparing program means for preparing an e-email message containing one or more of said digital image files selected by a user as e-email message attachments; and
email transmittal program means for sending said e-email message;
said email preparing program means including first means for automatically addressing said e-email message with a predefined Internet address, said predefined Internet address being the Internet address of a private fileserver attached to the Internet and wherein said email transmittal program means includes means for sending said email message to said first predefined Internet address.

15. A wireless image transmission system comprising in combination:
a 3G-camera phone, said 3G-camera phone including a microphone, a speaker, a keypad, a display, a programmed microprocessor, a memory, an RF transmitter, an RF receiver, and a digital camera;
said digital camera for taking a picture and holding that picture in a memory as a digital image file;
said keypad including:
at least one selection key means for enabling user selection of a digital image file for transmission from said 3G-camera phone; and
at least one transfer key means for initiating wireless transmission of a copy of said digital image file from said 3G-camera phone to the telephone number of a second telephone user, said transfer key means including means for momentarily breaking the telephone connection (“flashing the line”);
a private fileserver, said fileserver including a programmed microprocessor, a connection to the Internet, an email address, and a lookup table;
said lookup table containing telephone user telephone numbers and correlating such telephone numbers with the configuration of the respective user station associated with that telephone number, said configuration being any of a narrowband PTSN POTS line, a broadband DSL line, or a CATV line;
said programmed microprocessor of said 3G-camera phone including an email program for automatically creating an email message in response to operation of said transfer key means, attaching said copy of a user selected digital image file to said email message, tagging said user selected digital image file with a target telephone number, and sending said email message with file attachments via the Internet to the email address of said private fileserver;
said private fileserver including means for extracting at least said target telephone number from said user selected digital image file, determining if said extracted target telephone number appears in said lookup table, and, if that determination is affirmative, identifying the configuration of the user station associated with that telephone number.

16. The wireless image transmission system as defined in claim 15, further comprising: a image viewing device for receiving, storing and displaying image files, said image viewing device being associated with a telephone at an associated user station.

17. The wireless image transmission system as defined in claim 16, wherein said image viewing device includes:
a keypad; a microphone, a speaker, a display, and a programmed microprocessor;
a dial up modem for transmitting binary image files via a narrowband PTSN POTS line connection to the Internet;
dialing means for dialing a selected telephone number, including the telephone number of a target 3G-camera phone;
means for selecting a stored image file;
transfer key means for initiating transmission of a copy of said digital image file from said image viewing device to the email address of said 3G-camera phone, said transfer key means including means for momentarily breaking the telephone connection (“flashing the line”);
said programmed microprocessor of said image viewing device including an email program for automatically creating an email message in response to operation of said transfer key means, attaching said copy of said user selected digital image file to said email message, addressing said email message with the target 3G telephone number, and sending said email message with file attachments to said target telephone number.

18. An electronic binary digital file transfer system for sending a binary digital file from one of a wireless telephone positioned at one geographic location and an electronic appliance associated with a standard telephone positioned at a different geographic location to the other one thereof, during the course of a telephone connection established between said wireless telephone and either said electronic appliance or said standard telephone associated with said electronic appliance, said standard telephone being accessible for voice communication via a wireless network and any of the public switched telephone network (“PSTN telephone network”) or the Internet network, said wireless telephone being in wireless communication with said wireless network and said standard telephone being in communication with one of said PSTN network and Internet network; each of said wireless network and said PSTN telephone network including access to said Internet network; each of said PSTN telephone network and said wireless network respectively providing call waiting service, said system comprising:
each of said wireless telephone and said electronic appliance including means for storing binary digital files at least temporarily; means for opening binary digital files;
means for flashing any voice communication link established between said wireless telephone and either of said standard telephone and said electronic appliance over any of said networks, whereby said voice communication link is placed on hold by call waiting service and a dial tone is returned to respective one of said wireless telephone and said electronic appliance to enable establishment of a data connection while said communication link is on hold; and means for establishing a data communication link between said wireless telephone and said electronic appliance via at least said wireless network and one of said PSTN telephone network and said Internet network; and
means for sending said stored binary digital file over said data communication link, directly or indirectly, from one of said wireless telephone and said electronic appliance to the other one thereof.

19. The electronic binary digital file transfer system as defined in claim 18, further comprising:
a system fileserver, said system fileserver being connected to said Internet network and possessing an email address; and
wherein said means for sending said stored binary digital file over said data communication link, directly or indirectly, from one of said wireless telephone and said electronic appliance to the other one thereof includes:
means for preparing an email message to said other one of said wireless telephone and said electronic appliance;
means for addressing said email message to the email address of said system fileserver;
means for tagging said stored binary digital file with an access number of said other one of said wireless telephone and said electronic appliance, and attaching said tagged stored binary digital file to said email message as an attachment;
means for accessing said Internet network; and
means for sending said email message via said Internet to said email address of said system fileserver.

20. The electronic binary digital file transfer system as defined in claim 19, wherein said system fileserver includes:
a lookup table, said lookup table including configuration information for the each electronic appliance associated with a standard telephone, said configuration information including an access number; and further comprising:
means for receiving an email message;
means for parsing said attachment to said received email message to secure said access number tagged to said attachment;
checking means for determining from said configuration information at said network fileserver if said other one of said wireless telephone and said electronic appliance that is associated with said access number communicates via a plain old telephone line (narrowband PTSN “POTS” line), wirelessly, a broadband DSL line or CATV line, and, if said electronic appliance communicates through either a broadband DSL or a CATV line, returning an Internet email address, but otherwise returning a telephone number associated with said access number;
means for automatically dialing said telephone number of the standard telephone or wireless phone returned by said checking means over said PSTN telephone network if said checking means of said system fileserver determined that said image viewing device is not connected to a broadband DSL line or CATV line; OR
means for re-addressing said received email message to said Internet email address returned by said checking means of said system fileserver, and forwarding said re-addressed email message over said Internet with said attachments to the email address returned by said fileserver, if said fileserver determined that said image viewing device is connected to a broadband DSL line or CATV line.

21. The electronic binary digital file transfer system as defined in claim 20, wherein said binary digital file comprises an image file; wherein said wireless telephone comprises a 3G-camera phone; and wherein said electronic appliance comprises an image viewing device.

22. The electronic binary digital file transfer system as defined in claim 18, wherein said binary digital file comprises an image file; wherein said wireless telephone comprises a 3G-camera phone; wherein said electronic appliance comprises an image viewing device; and wherein said one of said wireless telephone and said electronic appliance comprises said 3G-camera phone and said other one of said wireless telephone and said electronic appliance comprises said image viewing device.

23. The electronic binary digital file transfer system as defined in claim 18, wherein said binary digital file comprises an image file; wherein said wireless telephone comprises a 3G-camera phone; wherein said electronic appliance comprises an image viewing device; and wherein said one of said wireless telephone and said electronic appliance comprises said image viewing device and said other one of said wireless telephone and said electronic appliance comprises said 3G-camera phone.

24. An electronic binary digital file transfer system for sending an image captured in a 3G-camera phone as a digital data file from one geographic location via the Internet to an image viewing device associated with a standard telephone that is positioned at a different geographic location during the course of a telephone connection established between said 3G-camera phone and said standard telephone, said standard telephone being accessible via a wireless network and the public switched telephone network (“PSTN telephone network”) for voice communication, said 3G-camera phone being in wireless communication with said wireless network and said telephone being in wired communication with said PSTN network; each of said wireless network and said PSTN telephone network including access to the Internet; each of said PSTN telephone network and said wireless network respectively providing call waiting service to said telephone line and said 3G-camera phone, respectively, said transfer system comprising:
means for at least temporarily storing said captured image at said 3G-camera phone as a digital data file;
means for flashing any voice communication link over said networks then established between said 3G-camera phone and said standard telephone, whereby said voice communication link is placed on hold by said wireless network and said PSTN network and a dial tone is returned by said wireless network to said 3G-camera phone to enable establishment of a data connection;
means for establishing a data communication link from said 3G-camera phone to at least said wireless network; and
means for sending said digital binary data file over said data communication link, directly or indirectly, to said image viewing device, whereby the image contained in said digital binary data file may be displayed by said image viewing device.

25. The electronic binary digital file transfer system as defined in claim 24, further comprising:
a system fileserver, said system fileserver being connected to said Internet network and possessing an Internet email address; and
wherein said means for sending said digital binary data file includes:
means for preparing an email message for an intended recipient of said digital data file;
means for addressing said email message to the email address of said system fileserver;
means for tagging said digital data file with the telephone number of said standard telephone of said intended recipient and attaching said tagged digital data file to said email message as an attachment;
means for accessing said Internet network; and
means for sending said email message via said Internet to said email address of said system fileserver.

26. The system for sending an image captured in a 3G-camera phone as defined in claim 25, wherein said system fileserver includes a lookup table, said lookup table including configuration information for the respective image viewing device associated with respective individual telephone numbers; and further comprising:
means for receiving said email message with attachments from said 3G-camera phone and parsing said attachments to secure the telephone number of the intended recipient tagged therein;
means for determining from said configuration at said network fileserver if an image viewing device associated with the telephone number of the intended recipient communicates via a plain old telephone line (“narrowband PTSN POTS” line), a broadband DSL line or CATV line, and, if said image viewing device communicates through either a broadband DSL line or CATV line, returning an Internet email address, but otherwise returning the telephone number of the standard telephone of said intended recipient found in said image file;
means for automatically dialing said telephone number of the standard telephone of said intended recipient found in said image file over said PSTN telephone network via a modem, if said fileserver determined that said image viewing device is not connected to a broadband DSL line or CATV line; OR
means for re-addressing said email message to said Internet email address returned by said fileserver, and forwarding said re-addressed email message over said Internet with said attachments to the email address returned by said fileserver, if said fileserver determined that said image viewing device is connected to a broadband DSL line or CATV line.

27. The system for sending an image captured in a 3G-camera phone as defined in claim 24, further comprising the following: a system fileserver for the system, said system fileserver including a lookup table; and said lookup table including configuration information for the respective image viewing device associated with respective individual telephone numbers.

28. The system for sending an image captured in a 3G-camera phone as defined in claim 25, wherein said means for determining if an image viewing device at the location of the standard telephone identified by the telephone number of the intended recipient communicates through a plain telephone line, a broadband DSL or CATV line, further comprises:
means for reading the target voice telephone number tagged to said image file, said target telephone number being the telephone associated with said image viewing device;
means for searching said lookup table for said target telephone number, said lookup table comprising a correlation of telephone numbers with the line configuration information for the image viewing device located at each of said telephone numbers, said line configuration information providing logical indication of whether the respective line configuration information indicates a standard telephone (“narrowband PTSN POTS”) line, a broadband DSL or CATV line and providing an Internet email address for the respective broadband DSL or CATV line, if said line configuration information logically indicates either a broadband DSL or CATV line, and, if a broadband DSL or CATV line is not indicated, returning said target telephone number.

29. The system for sending an image captured in a 3G-camera phone as defined in claim 28, wherein said 3G-camera phone comprises:
memory means for storing at least said digital binary data files;
dialing means for at least initiating establishment of a first telephone connection via at least said wireless network to said telephone for conducting a voice call;
transfer key means, responsive to user actuation, for initiating a pause of said voice call, establishment of a data connection to said image viewing device and transmittal of at least one of said digital binary data files to said image viewing device.

30. A programmed fileserver for an image file transfer system, said programmed fileserver having a private email address for receiving and handling email messages, including at least one image file attachment, for said image file transfer system, and a lookup table, said lookup table including a plurality of telephone numbers and configuration information in respect to each of said telephone numbers, and further including:
program means for inspecting a received image file attached to a received email message for the presence of a called party telephone number and, responsive to locating therein a called party telephone number, extracting said called party telephone number there from and comparing said called party telephone number with telephone numbers listed in said lookup table to locate a match there between; and, upon finding a match there between
determining if said lookup table contains an Internet address that correlates to said matching telephone number; and, if said determination is affirmative,
replacing said called party telephone number in said email attachment with said Internet address; and
forwarding said email attachment via said Internet to said Internet address listed in said attachment; but if said determination is negative,
restoring said email message and attachments to the original state and forwarding said email attachment to said called party telephone number.

31. The programmed fileserver as defined in claim 30, wherein restoring said email message and attachments to the original state further comprises:
MIME decoder means for MIME decoding each said attachment back to the original source format.

32. An image viewing device for use in an image transfer system for at least, respectively, receiving and/or sending digital image files from and to a 3G-camera phone via any of a narrowband network connection or a broadband network connection, comprising at least:
a programmed general purpose computer and a modem;
said computer including:
means for detecting a call waiting tone and, responsive thereto, for flashing the telephone line;
means for receiving and authenticating an incoming data call;
means for receiving and storing email, including image files attached to said email; and
means for generating a DTMF tone to signal completion of reception of said email.

33. The image viewing device of claim 32 further comprising:
display means for displaying image files;
a graphics display controller;
a processor; and
a memory;

34. The image viewing device of claim 33 wherein said programmed computer further includes an Ethernet port.

35. An image viewing device for use in an image transfer system for at least, receiving digital image files from a 3G-camera phone via any of a narrowband network connection or a broadband network connection, comprising at least:
a programmed general purpose computer and a modem;
said computer including:
means for detecting a call waiting tone and, responsive thereto, for flashing the telephone line;
means for receiving and authenticating an incoming data call;
means for receiving and storing email, including image files attached to said email; and
means for generating a DTMF tone to signal completion of reception of said email.

36. A method for sending an image captured in a 3G-camera phone to an image viewing device that is connected to the telephone (“narrowband PTSN POTS”) line of a standard telephone that is accessible through the PSTN telephone network and sending that image during the course of a telephone call established between said 3G-camera phone and a called party at said standard telephone, said 3G-camera phone being in wireless communication with a wireless network; each of said wireless network and said PSTN telephone network including access to the Internet network; each of said PSTN telephone network and said wireless network respectively providing call waiting service to said telephone line and said 3G-camera phone, respectively, comprising the steps of:
dialing the telephone number of a standard telephone from said 3G-camera phone to establish a voice communication link with said standard telephone over the wireless network and PSTN network;
selecting an image file stored in said 3G-camera phone for transmission from said 3G-camera phone;
initiating the transmission of said selected image file to an image viewing device associated with said standard telephone; and
transmitting said selected image file to said image viewing device;
wherein said step of initiating the transmission of said image file to said image viewing device includes the steps of (a) preparing an email addressed to the private email address of a fileserver, tagging said image file with the telephone number of said standard telephone line, attaching said image file to said email message and (b) flashing any voice communication link then existing at said handset to place said voice communication link on hold; and
wherein said step of transmitting said image file to said image viewing device includes the steps of (a) sending said email to said fileserver via the Internet;
(b) at said fileserver determining the telephone number tagged on said image file attached to said email received from said 3G-camera phone,
(c) determining the type of communication line associated with the image viewing device located at said telephone number from a lookup table maintained on said fileserver,
(d) selecting the appropriate medium for sending said image file to said image viewing device based on the type of communication line so determined,
(e) sending said image file, whereby said image viewing device receives and displays the digital image file, and
(f) re-flashing said communication link of said wireless provider network following said step of sending said image file to reactivate said voice connection.
